(19) United States
(12) Patent Application Publication
(10) Pub. No.: US 2008/0085946 A1
(43) Pub. Date: Apr. 10, 2008

(54) PHOTO-TAILORED SHAPE MEMORY ARTICLE, METHOD, AND COMPOSITION

(76) Inventors: Patrick T. Mather, Chagrin Falls, OH (US); Kyung Min Lee, Cuyahoga Falls, OH (US)

Correspondence Address: CANTOR COLBURN, LLP, 20 Church Street, 22nd Floor, Hartford, CT, 06103, US

(21) Appl. No.: 11/838,613

(22) Filed: Aug. 14, 2007

Related U.S. Application Data
(60) Provisional application No. 60/822,264, filed on Aug. 14, 2006.

(51) Int. Cl. C08F 2/46; B29C 45/00; B29C 47/00; B29C 49/00

(52) U.S. Cl. 522/4; 264/459; 264/477; 264/478; 522/154; 528/27; 528/356

(57) ABSTRACT

A method of forming a photo-tailored shape memory article is described. The method includes forming an article that includes a photochemically crosslinkable polymer composition, illuminating at least two different regions of the article with different light exposures to form first and second crosslinked polymer compositions with different shape memory critical temperatures. Also described are photochemically crosslinkable polymer compositions that include a di(meth)acrylate macromer, a multifunctional thiol, and a photoinitiator.

### CROSS REFERENCE TO RELATED APPLICATIONS

This application claims the benefit of U.S. Provisional Application Ser. No. 60/822,264 filed Aug. 14, 2006. This provisional application is incorporated herein by reference.

### BACKGROUND OF THE INVENTION

Shape memory materials are those materials that have the ability to “memorize” a permanent shape, be manipulated and “fixed” to a temporary or dormant shape under specific conditions of temperature and stress, and then later relax to the original, stress-free, condition under thermal, electrical, or environmental command. This relaxation is associated with elastic deformation stored during the fixing step. When the relaxation is thermally stimulated, it occurs at a shape memory critical temperature characteristic of the material. A shape memory effect can be achieved through multiple distinct approaches, each using a particular mechanism for strain (and shape) fixing and shape recovery/rubber elasticity. In the case of semicrystalline polymers and semicrystalline shape memory polymer blends, strain fixing is enabled by vitrification at the glass transition temperature (T_{g}) and shape recovery by rubber elasticity is derived from the physical crosslinks of a minor crystalline phase. In semicrystalline elastomers, strain fixing is enabled by percolating crystalline phases, while shape recovery and elasticity is achieved by chemical crosslinks. Castable glassy thermosets (CGT) are capable of fixing strain through vitrification at T_{g} and shape recovery is possible due to rubber elasticity derived from covalent crosslinks. Shape memory polymers of the CGT type have been achieved by copolymerizing two monofunctional monomers (the types and amounts of which tailor the glass transition temperature) and a multifunctional monomer that provides crosslinking. The polymerization and crosslinking may be achieved using a free-radical initiator that is either thermally activated or photoactivated.

Known shape memory polymers are generally capable of exhibiting one or in a few cases two shape changes on increasing temperature. In order to fabricate complex shape memory articles capable of multi-stage deployment over a range of temperature, it would be highly desirable to have a process in which shape memory articles that exhibit multiple shape memory critical temperatures can be created from a single shape memory polymer composition.

### BRIEF DESCRIPTION OF THE INVENTION

The above-described and other drawbacks are alleviated by a method of forming a photo-tailored shape memory article, comprising: forming an article comprising a photochemically crosslinkable polymer composition; illuminating a first region of the article with a first light exposure to photochemically crosslink the photochemically crosslinkable polymer composition, thereby creating a first crosslinked polymer having a first shape memory critical temperature; and illuminating a second region of the article with a second light exposure different from the first light exposure to photochemically crosslink the photochemically crosslinkable polymer composition, thereby creating a second crosslinked polymer having a second shape memory critical temperature.

Another embodiment is a method of forming a photo-tailored shape memory article, comprising: forming an article comprising a photochemically crosslinkable polymer composition; wherein the photochemically crosslinkable polymer composition comprises a bifunctional telechelic polymer wherein each of the two functional groups comprises a carbon-carbon double bond, a multifunctional thiol, and a substituted or unsubstituted benzophenone; illuminating a first region of the article with a first light exposure to photochemically crosslink the photochemically crosslinkable polymer composition, thereby creating a first crosslinked polymer having a first shape memory critical temperature; and illuminating a second region of the article with a second light exposure different from the first light exposure to photochemically crosslink the photochemically crosslinkable polymer composition, thereby creating a second crosslinked polymer having a second shape memory critical temperature.

Another embodiment is a method of forming a photo-tailored shape memory article, comprising: forming an article comprising a photochemically crosslinkable polymer composition; wherein the photochemically crosslinkable polymer composition comprises an allyl diterminated polyurethane, pentaerythritol tetra(3-mercaptopropionate), and benzophenone; illuminating a first region of the article with a first ultraviolet light exposure to photochemically crosslink the photochemically crosslinkable polymer composition, thereby creating a first crosslinked polymer having a first shape memory critical temperature; and illuminating a second region of the article with a second ultraviolet light exposure different from the first ultraviolet light exposure to photochemically crosslink the photochemically crosslinkable polymer composition, thereby creating a second crosslinked polymer having a second shape memory critical temperature.

Another embodiment is a method of forming a photo-tailored shape memory article, comprising: forming an article comprising a photochemically crosslinkable polymer composition; wherein the photochemically crosslinkable polymer composition comprises a polycaprolactone di(meth)acrylate, pentaerythritol tetra(3-mercaptopropionate), and benzophenone; illuminating a first region of the article with a first ultraviolet light exposure to photochemically crosslink the photochemically crosslinkable polymer composition, thereby creating a first crosslinked polymer having a first shape memory critical temperature; and illuminating a second region of the article with a second ultraviolet light exposure different from the first ultraviolet light exposure to photochemically crosslink the photochemically crosslinkable polymer composition, thereby creating a second crosslinked polymer having a second shape memory critical temperature.

Another embodiment is a method of programming a photo-tailored shape memory article, comprising: heating an article comprising a first photochemically crosslinked polymer composition having a first shape memory critical temperature, and a second photochemically crosslinked polymer composition spatially separated from the first photochemically crosslinked polymer composition and having a second shape memory critical temperature to a temperature greater than the first shape memory critical temperature and the second shape memory critical temperature; wherein the first shape memory critical temperature and the second shape memory critical temperature are different; deforming the first photochemically crosslinked polymer to impress a first desired temporary shape, and deforming the second photochemically crosslinked polymer to impress a second desired temporary shape; and cooling the article to a temperature below the first shape memory critical temperature and the second shape memory critical temperature.

Another embodiment is a sensor for determining whether any of a plurality of predetermined temperatures have been exceeded, comprising: a photo-tailored shape memory sensor comprising a plurality of photochemically crosslinked polymer compositions; wherein each photochemically crosslinked polymer composition is the product of photochemically crosslinking the same photochemically crosslinkable composition, and each photochemically crosslinked polymer composition varies from at least one other in the extent of crosslinking; wherein each photochemically crosslinked polymer composition has a known shape memory critical temperature; and wherein each photochemically crosslinked composition is embossed with a temporary shape indicative of its known shape memory critical temperature.

Another embodiment is a sensor for determining whether any of a plurality of predetermined temperatures have been exceeded, comprising: a photo-tailored shape memory sensor comprising a plurality of photochemically crosslinked polymer compositions; wherein each photochemically crosslinked polymer composition is the product of photochemically crosslinking the same photochemically crosslinkable composition, and each photochemically crosslinked polymer composition varies from all of the others in the extent of crosslinking; wherein each photochemically crosslinked polymer composition has a known shape memory critical temperature; wherein each photochemically crosslinked composition is embossed with a permanent shape indicative of its known shape memory critical temperature; and wherein each photochemically crosslinked composition has a temporary shape different from the embossed permanent shape.

Another embodiment is a crosslinked polymer network, comprising the product of photochemically crosslinking a composition comprising polycaprolactone di(meth)acrylate macromer, a multifunctional thiol, and a photoinitiator.

Another embodiment is a crosslinked polymer network, comprising repeating units having the structure 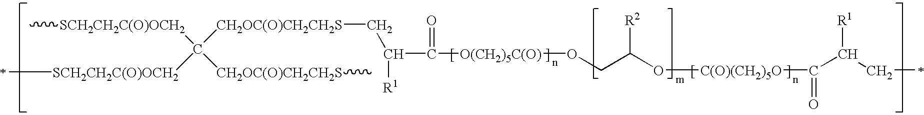
wherein each occurrence of R¹ and R² is independently hydrogen or methyl; each occurrence of m is independently 1 to about 10; each occurrence of n is independently 1 to about 20; and each wavy bond is a bond either to a hydrogen atom or another polycaprolactone di(meth)acrylate unit.

Another embodiment is a crosslinked polymer network, comprising the product of photochemically crosslinking a composition comprising: a telechelic polymer selected from the group consisting of di(meth)acrylate esters of polyhedral oligosilsesquioxane diol-initiated poly(ε-caprolactone)s, di(meth)acrylate esters of polyhedral oligosilsesquioxane diol-initiated polylactide-polyglycolide random copolymers, and di(meth)acrylate esters of poly(ethylene oxide)s; a multifunctional thiol, and a photoinitiator.

Another embodiment is a polyhedral oligosilsesquioxane diol-initiated poly(ε-caprolactone) having the structure 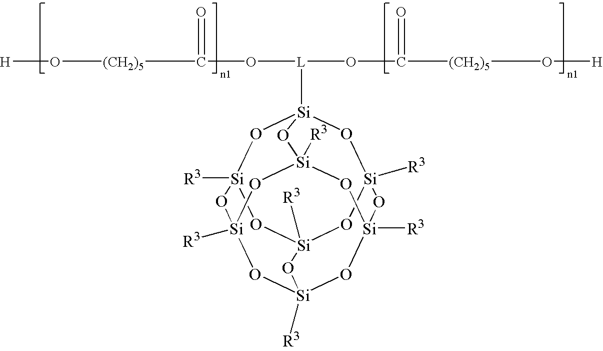
wherein each occurrence of R³ is independently optionally substituted C₁-C₁₂ hydrocarbyl, L is an optionally substituted C₂-C₂₄ trivalent hydrocarbyl linking group, and each occurrence of n1 is independently 1 to 30 provided that the sum of both occurrences of n1 is at least 4.

Another embodiment is a polyhedral oligosilsesquioxane diol-initiated poly(ε-caprolactone) di(meth)acrylate having the structure 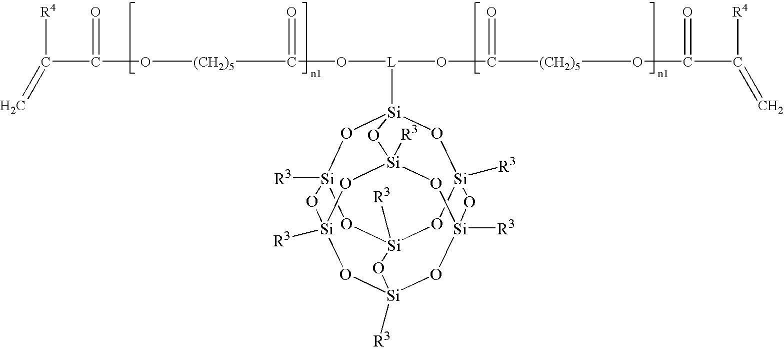
wherein each occurrence of R³ is independently optionally substituted C₁-C₁₂ hydrocarbyl, each occurrence of R⁴ is independently hydrogen or methyl, L is an optionally substituted C₂-C₂₄ trivalent hydrocarbyl linking group, and each occurrence of n1 is independently 1 to 30 provided that the sum of both occurrences of nil is at least 4.

Another embodiment is a polyhedral oligosilsesquioxane diol-initiated poly(d,1-lactide-co-glycolide) diol having the structure 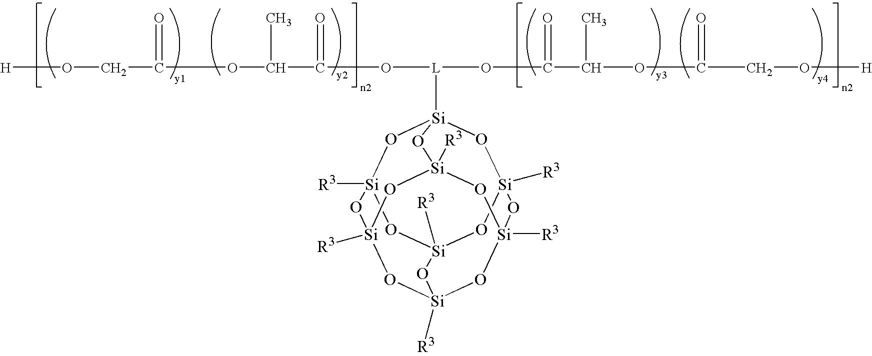
wherein each occurrence of R³ is independently optionally substituted C₁-C₁₂ hydrocarbyl, L is an optionally substituted C₂-C₂₄ trivalent hydrocarbyl linking group, each occurrence of y1, y2, y3, and y4 is independently 0.1 to 0.9 provided that the sum of y1 and y2 is 1 and the sum of y3 and y4is 1, and each occurrence of n2 is independently 1 to 30 provided that the sum of both occurrences of n2 is at least 4.

Another embodiment is a polyhedral oligosilsesquioxane diol-initiated poly(d,1-lactide-co-glycolide) di(meth)acrylate having the structure 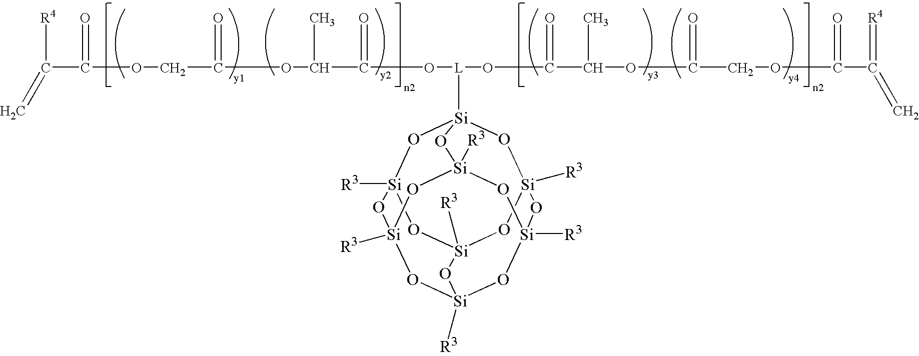
wherein each occurrence of R³ is independently optionally substituted C₁-C₁₂ hydrocarbyl, each occurrence of R⁴ is independently hydrogen or methyl, L is an optionally substituted C₂-C₂₄ trivalent hydrocarbyl linking group, each occurrence of y1, y2, y3, and y4 is independently 0.1 to 0.9 provided that the sum of y1 and y2 is 1 and the sum of y3 and y4is 1, and each occurrence of n2 is independently 1 to 30, specifically 2 to 20, provided that the sum of both occurrences of n2 is at least 4.

Other embodiments, including shape memory articles prepared by the above methods, are described in detail below.

### BRIEF DESCRIPTION OF THE DRAWINGS

FIG. 1 shows differential scanning calorimetry (DSC) curves for four differentially photocured regions of a shape memory article.

FIG. 2 part (i) shows photographic images of the permanent (stress-free) shapes of shape memory articles comprising, from left to right, 1, 2.5, 5, and 10 weight percent boron nitride; part (ii) shows the same articles after they were heated to 80° C., bent into a temporary shape, and cooled to room temperature; part (iii) shows the same articles which, after being fixed into the temporary shapes shown in part (ii), were heated to 80° C. for 5 seconds to restore their permanent shapes.

FIG. 3 illustrates fixing of and recovery from a temporary embossed shape; part (a) shows the sample at 100× magnification before embossing; part (b) shows the sample from (a) at 200× magnification after it was heated to 70° C. and embossed at that temperature with two kilograms force for five seconds, and cooled to room temperature; part (c) shows the sample from (b) at 100× magnification after it was heated to 70° C. at which temperature de-embossing occurred.

FIG. 4 shows ¹H NMR spectra of a polycaprolactone diol precursor and a polycaprolactone macromer.

FIG. 5 shows DSC results for a polycaprolactone diol, a polycaprolactone macromer, and a polycaprolactone network.

FIG. 6 is a two-dimensional representation of the shape memory behavior of a polycaprolactone network through three thermal cycles.

FIG. 7 is a three-dimensional representation of the shape memory behavior of a polycaprolactone network through three thermal cycles.

FIG. 8 shows three thermal shape memory cycles for a POSS-PCL-2K network (left) and a POSS-PCL-2.5K network (right).

FIG. 9 shows DSC results for ethylene glycol-initiated PLGA50 diols, macromers, and networks; the scanning rate was 10° C./minute under N₂ atmosphere.

FIG. 10 is a three-dimensional representation of the shape memory behavior of a PLGA50-2K network through three thermal cycles.

FIG. 11 shows DSC results for POSS-initiated PLGA50 diols, macromers, and networks; the scanning rate was 10° C./minute under N₂ atmosphere.

FIG. 12 is a three-dimensional representation of the shape memory behavior of a POSS-PLGA50-3K network through three thermal cycles.

FIG. 13 shows degradation profiles for PLGA50 networks and POSS-PLGA50 networks in buffered solution at 37° C.

FIG. 14 is a proton nuclear magnetic resonance (¹H NMR) spectrum of a PEG-2K macromer, with peak assignments referenced to the chemical structure.

FIG. 15 shows DSC results for (a) PEG-4K, PEG-6K, PEG-8K and macromers, (b) PEG-4K networks having different mol ratio of PEG to crosslinker, and (c) PEG-6K networks having different mol ratio of PEG to crosslinker.

FIG. 16 provides three-dimensional representations of the shape memory behaviors of a PEG-4K network (left) and a PEG-6K network (right) through three thermal cycles.

### DETAILED DESCRIPTION OF THE INVENTION

The present inventors have conducted extensive research in an effort to provide an improved and simplified method fabricating complex shape memory articles capable of multi-stage deployment over a range of temperatures. They have discovered that the combination of differential photocuring and the selection of particular photochemically curable compositions permits a single shape memory polymer composition to be used in the fabrication of a shape memory article with different shape memory transition temperatures in different regions of the article. In other words, complex articles can be created by “photo-tailoring” a single chemical composition. Thus, one embodiment is a method of forming a photo-tailored shape memory article, comprising: forming an article comprising a photochemically crosslinkable polymer composition; illuminating a first region of the article with a first light exposure to photochemically crosslink the photochemically crosslinkable polymer composition, thereby creating a first crosslinked polymer having a first shape memory critical temperature; and illuminating a second region of the article with a second light exposure different from the first light exposure to photochemically crosslink the photochemically crosslinkable polymer composition, thereby creating a second crosslinked polymer having a second shape memory critical temperature.

This method comprises forming an article comprising a photochemically crosslinkable polymer composition. The curable compositions may have a variety of viscosities, depending on the chemical components and the processing temperature. Selection of an article forming method will depend on the particular viscosity of the curable composition at the desired processing temperature. Suitable article forming methods include, for example, liquid casting (for example, when the curable composition is a low-viscosity liquid), solution casting (for example, when casting a solvent solution of the curable composition), melt processing, film extrusion, sheet extrusion, injection molding, compression molding, blow molding, embossing, laminating, and the like, and combinations thereof.

In general, the photochemically crosslinkable polymer composition is any polymer-containing composition that (1) can be photochemically crosslinked to greater or lesser degrees depending on the photochemical exposure, and (2) exhibits shape memory behavior after being photochemically crosslinked. In some embodiments, the photochemically crosslinkable polymer composition comprises a castable glassy thermoset. A castable glassy thermoset, which is amendable to cure in an open mold (for example, in a mold exposed to the air), is defined herein as a thermoset (1) having in its curable form a vapor pressure at 25° C. less than 1 kilopascal; (2) having in its curable form a viscosity of about 10 to about 1000 millipascal-seconds (mPa•s), and (3) having in its cured form an amorphous (glassy) morphology characterized by a glass transition temperature, T_{g}. Articles formed from the cured castable glassy thermoset have an equilibrium shape, the ability to fix strains (imparted above T_{g}) by vitrification below T_{g} thereby forming a temporary shape, and a network structure that enables them to recover the equilibrium shape from the temporary shape by heating to a temperature greater than T_{g}. Examples of castable glassy thermosets include the copolymers of methyl methacrylate, butyl methacrylate, and tetraethylene glycol dimethacrylate described in U.S. Patent Application Publication No. US 2004/0030062 A1 of Mather et al.

In some embodiments, the photochemically crosslinkable polymer composition comprises a castable semicrystalline thermoset. A castable semicrystalline thermoset is defined herein as a thermoset (1) having in its curable form a vapor pressure at 25° C. less than 1 kilopascal; (2) having in its curable form a viscosity of about 10 to about 1000 millipascal-seconds (mPa•s), and (3) having in its cured form a semicrystalline morphology characterized by a melting temperature, Tₘ. Articles formed from the cured castable semicrystalline thermoset have an equilibrium shape, the ability to fix strains (imparted above Tₘ) by crystallization below Tₘ thereby forming a temporary shape, and a network structure that enables them to recover the equilibrium shape from the temporary shape by heating to a temperature greater than Tₘ. Examples of castable semicrystalline thermosets include poly(ethylene glycol) di(meth)acrylate macromers, copolymers of stearyl acrylate and methyl acrylate crosslinked with N,N′-methylenebis(acrylamide) as described in Y. Kagami, J. P. Gong, Y. Osada, Macromolecular Rapid Communications (1996), 17(8), 539-543, and the macromers described below (some of which require solvent addition to meet the stated viscosity limitation).

In some embodiments, the photochemically crosslinkable polymer composition comprises a telechelic polymer, a multifunctional crosslinlcing agent, and a polymerization initiator. In general, the telechelic polymer and the multifunctional crosslinking agent are capable of reacting to form a covalent bond between them in a chemical reaction catalyzed by the polymerization initiator. In other words, the telechelic polymer and the multifunctional crosslinking agent are reactants in a chemical crosslinking reaction catalyzed by the polymerization initiator. The term “telechelic polymer” refers to polymers having one or more end groups wherein the end group has the capacity to react with another molecule. Telechelic polymers having one reactive end group per molecule are said to be monofunctional. Telechelic polymers having two reactive end groups per molecule are said to be bifunctional. Telechelic polymers having more than two reactive end groups per molecule are said to be multifunctional. Examples of reactive end groups include aliphatic carbon-carbon double bonds, aliphatic carbon-carbon triple bonds, and carbon-nitrogen triple bonds. In some embodiments, the reactive end groups are aliphatic carbon-carbon double bonds capable of reacting with a thiol in a thiol-ene reaction. In some embodiments, the telechelic polymer is a bifunctional telechelic polymer wherein each of the two functional groups comprises an aliphatic carbon-carbon double bond. In some embodiments, the telechelic polymer is a bifunctional telechelic polymer wherein each of the two functional groups is independently selected from the group consisting of vinyl, allyl, (meth)acryl, styryl, benzyl, maleimide, ethynyl, phenyl-ethynyl, and propargyl. As used herein, the prefix “(meth)acryl-” means “methacryl-” or “acryl-”. For example, “butyl (meth)acrylate” may be butyl acrylate, butyl methacrylate, or a mixture thereof. In some embodiments, the telechelic polymer is a telechelic biodegradable polymer. Suitable telechelic biodegradable polymers include, for example, di(meth)acrylate esters of polycaprolactone diols, di(meth)acrylate esters of polycaprolactone-polylactide random copolymers, di(meth)acrylate esters of polycaprolactone-polyglycolide random copolymers, di(meth)acrylate esters of polycaprolactone-polylactide-polyglycolide random copolymers, di(meth)acrylate esters of polylactide-polyol random copolymers, di(meth)acrylate esters of polycaprolactone-poly(β-hydroxybutyric acid) random copolymers, di(meth)acrylate esters of poly(β-hydroxybutyric acid), di(meth)acrylate esters of polyhedral oligosilsesquioxane diol-initiated (POSS diol-initiated) poly(ε-caprolactone)s, di(meth)acrylate esters of POSS diol-initiated polylactide-polyglycolide random copolymers, di(meth)acrylate esters of poly(ethylene oxide)s, and the like, and mixtures thereof.

Some of the telechelic polymers contain internal POSS units derived from POSS diol-initiated polymerization of a cyclic ester or a mixture of two or more cyclic esters. The POSS diol used to initiate polymerization can be a compound containing a polyhedral oligosilsesquioxane moiety and a diol moiety, wherein a linking group joins the polyhedral oligosilsesquioxane moiety and the two hydroxy groups. Suitable POSS diols include those having the structure 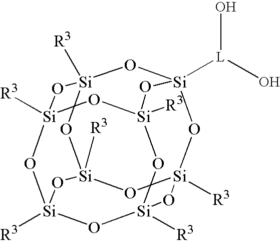
wherein each occurrence of R³ is independently C₁-C₁₂ hydrocarbyl (optionally substituted), and L is a C₂-C₂₄ trivalent hydrocarbyl linking group (optionally substituted) linking the polyhedral oligosilsesquioxane moiety to the two hydroxy groups shown. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as “optionally substituted”, the hydrocarbyl residue may also include one or more substituents such as halogens (including fluorine, chlorine, bromine, and iodine), carboxylic acid groups (—CO₂H), amino groups, amide groups, or the like, or it may contain heteroatoms such as nitrogen atoms, oxygen atoms, and silicon atoms within the backbone of the hydrocarbyl residue. Commercially available polyhedral oligosilsesquioxane diols include those provided by Hybrid Plastics™ Hattiesburg, MS or Aldrich Chemical (see generally “Silsesquioxanes, Bridging the Gap Between Polymers and Ceramics”, Chemfiles, Vol. 1, No. 6, 2001 (Aldrich Chemical)). Exemplary polyhedral oligosilsesquioxane diols include 1-(2,3-propanediol)propoxy-3,5,7,9,11,13,15-isobutylpentacyclo-[9.5.1.1^{3,9}.1^{3,9}.1^{5,15}.1^{7,13}]octasiloxane (“1,2-propanediolisobutyl-POSS” CAS # 480439-49-4); 1-(2,3-propanediol)propoxy-3,5,7,9,11,13,15-cyclohexylpentacyclo-[9.5.1.1^{3,9}.1^{5,15}.1^{7,13}]octasiloxane (“1,2-propanediolcyclohexyl-POSS”); 2-ethyl-2-[3-[[(heptacyclopentylpentacyclo-[9.5.1.^{3,9}.1^{5,15}.1^{7,13}]octasiloxanyl)oxy]dimethylsilyl]-propoxy]methyl]-1,3-propanediol (“TMP cyclopentyldiol-POSS” or “TMP Diolcyclopentyl-POSS”, CAS 268747-51-9); 2-ethyl-2-[3-[[(heptacyclohexylpentacyclo-[9.5.1.1^{3,9}.1^{5,15}.1^{7,13}]octasiloxanyl)oxy]dimethylsilyl]-propoxy]methyl]-1,3-propanediol (“TMP cyclohexyldiol-POSS”); 2-ethyl-2-[3-[[(heptaisobutylpentacyclo-[9.5.1.1^{3,9}.1^{5,15}.1^{7,13}]octasiloxanyl)oxy]dimethylsilyl]-propoxy]methyl]-1,3-propanediol (“TMP isobutyldiol-POSS” or “TMP diolisobutyl-POSS”); 1-(2-trans-cyclohexanediol)ethyl-3,5,7,9,11,13,15-cyclohexanepentacyclo-[9.5.1.1^{3,9}.1^{5,15}.1^{7,13}] octasiloxane (“trans-cyclohexanediolcyclohexane-POSS” or “transcyclohexanediolcyclohexyl-POSS”); 1-(2-trans-cyclohexanediol)ethyl-3,5,7,9,11,13,15-isobutylpentacyclo-[9.5.1.1^{3,9}.1^{5,15}.1^{7,13}]octasiloxane, (“transcyclohexanediolisobutyl-POSS”, CAS 480439-48-3); and 2-ethyl-2-[3-[[(heptaisobutylpentacyclo-[9.5.1.1^{3,9}.1^{5,15}.1^{7,13}]octasiloxanyl)oxy]-dimethylsilyl]propoxy]propane-1,3-diol.

Additional telechelic biodegradable polymers are described in U.S. Patent Application Publication No. US 2005/0245719 A1 of Mather et al. In some embodiments, the telechelic polymer has a glass transition temperature or a melting temperature of about 10 to about 80° C., specifically about 20 to about 75° C., more specifically about 30 to about 70° C., even more specifically about 40 to about 70° C. Examples of telechelic polymers include telechelic polyurethanes, telechelic polyesters (including ring-opening telechelic polyesters, such as poly(ε-caprolactone)), telechelic poly(allcyl (meth)acrylate)s, telechelic poly(alkylene oxide)s (including telechelic polyethylene oxides, telechelic polypropylene oxides, and telechelic copolymers of ethylene oxide and propylene oxide), and mixtures thereof.

The term “multifunctional crosslinking agent” refers to a compound having at least two functional groups that are capable of reacting with the reactive end groups of the telechelic polymer. The word “multifunctional” in the term “multifunctional crosslinking agent” indicates that the crosslinking agent has an average functionality greater than 2. For example, the multifunctional crosslinking agent may have an average functionality of at least 2.5, or at least 3, or at least 4, or at least 5, or at least 6. The multifunctional crosslinking agent may, optionally, act as a solvent for the telechelic polymer, such that the combined multifunctional crosslinking agent and telechelic polymer form a solution with a viscosity less than that of the telechelic polymer alone. Suitable classes of multifunctional crosslinking agents include multifunctional thiols, multifunctional cyanates, multifunctional (meth)acrylates, compounds containing multiple carbon-carbon double bonds, compounds containing multiple carbon-carbon triple bonds, and mixtures thereof. In some embodiments, the multifunctional crosslinking agent is a multifunctional thiol. Suitable multifunctional thiols include, for example, pentaerythritol tetramercaptopropionate, pentaerythritol tetramercaptoacetate, pentaerythritol tetrathioglycolate, trimethylolpropane trimercaptoacetate, trimethylolpropane trimercaptopropionate, 1,2,3-propanetrithiol, 1,2,6-hexanetrithiol, and the like, and mixtures thereof.

The term “polymerization initiator” includes photoinitiators, thermal initiators, and combinations thereof. In some embodiments, the polymerization initiator is a photoinitiator. Suitable photoinitiators include, for example, benzoin ethers, benzil ketals, α-dialkoxyacetophenones, α-hydroxyallylphenones, α-aminoalkylphenones, acylphosphine oxides, benzophenones, thioxanthones, the combination of camphorquinone (CQ) and ethyl-4-(dimethylamino)benzoate (EDMAB), and mixtures thereof. Suitable thermal initiators include, for example, azoisobutyronitrile (AIBN), benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, α,α-bis(t-butylperoxy-m-isopropyl)benzene, 2,5-dimethyl-2,5-di(t-butylperoxy)hexane, dicumyl peroxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, 2,3-dimethyl-2,3-diphenylbutane, 2,3-trimethylsilyloxy-2,3-diphenylbutane, and the like, and mixtures thereof.

The photochemically crosslinkable polymer need not be a telechelic polymer. In some embodiments, the photochemically crosslinkable polymer composition comprises a polymer comprising internal or pendant (not terminal) aliphatic unsaturation, a multifunctional crosslinking agent, and a polymerization initiator. For example, the photochemically crosslinkable polymer may be a polybutadiene or polyisoprene in which the reactive groups are in-chain carbon-carbon double bounds formed from 1,4-addition of the conjugated diene, or pendant carbon-carbon double bonds formed from 1,2-addition of the conjugated diene, or both.

The method comprises illuminating a first region of the article and illuminating a second region of the article. In some embodiments, each illumination independently comprises illuminating with light having a wavelength of about 200 to about 700 nanometers. Within this range, the wavelength may be at least about 250 nanometers, or at least about 300 nanometers. Also within this range, the wavelength may be up to about 500 nanometers, or up to about 400 nanometers. In some embodiments, illuminating the first region of the article and illuminating the second region of the article each comprises irradiating with an electron beam. Illumination may be varied continuously or discretely over different regions of the article.

The second light exposure is different from the first light exposure. The second light exposure may differ from the first light exposure in, for example, the duration of light exposure, the intensity (power) of light exposure, the wavelength of light exposure, or a combination thereof.

The photochemically crosslinkable polymer composition may, optionally, further include a filler. Suitable fillers include reinforcing fillers (e.g., glass fibers, which are useful to increase the modulus of the composition), conductive fillers (including both thermally conductive and electrically conductive fillers; e.g., graphite, single-wall and multi-wall carbon nanotubes, and boron nitride, which are useful to increase the thermal conductivity of the composition and thereby accelerate shape memory effects that involve heat transfer), and the like, and combinations thereof.

Illuminating the first region of the article creates a first crosslinked polymer having a first shape memory critical temperature, and illuminating the second region of the article creates a second crosslinked polymer having a second shape memory critical temperature. A “shape memory critical temperature” is a temperature at which, on heating, the composition having the shape memory critical temperature changes shape from its temporary shape to its permanent shape. A shape memory temperature may be, for example, a glass transition temperature, a melting temperature, a nematic-isotropic transition temperature, or a liquid crystalline-isotropic transition temperature. The different light exposures in the first and second regions may create different shape memory critical temperatures in those regions. In some embodiments, the first shape memory critical temperature and the second shape memory critical temperature are each independently about 10 to about 80° C., specifically about 20 to about 75° C., more specifically about 30 to about 70° C., still more specifically about 40 to about 70° C. In some embodiments, the first shape memory critical temperature and the second shape memory critical temperature differ by about 1 to about 20° C. Within this range, the difference may be at least about 5° C., or at least about 10° C. memory article, comprising: forming an article comprising a photochemically crosslinkable polymer composition; wherein the photochemically crosslinkable polymer composition comprises a bifunctional telechelic polymer wherein each of the two functional groups comprises a carbon-carbon double bond, a multifunctional thiol, and a substituted or unsubstituted benzophenone; illuminating a first region of the article with a first light exposure to photochemically crosslink the photochemically crosslinkable polymer composition, thereby creating a first crosslinked polymer having a first shape memory critical temperature; and illuminating a second region of the article with a second light exposure different from the first light exposure to photochemically crosslink the photochemically crosslinkable polymer composition, thereby creating a second crosslinked polymer having a second shape memory critical temperature.

One embodiment is a method of forming a photo-tailored shape memory article, comprising: forming an article comprising a photochemically crosslinkable polymer composition; wherein the photochemically crosslinkable polymer composition comprises an allyl diterminated polyurethane, pentaerythritol tetra(3-mercaptopropionate), and benzophenone; illuminating a first region of the article with a first ultraviolet light exposure to photochemically crosslink the photochemically crosslinkable polymer composition, thereby creating a first crosslinked polymer having a first shape memory critical temperature; and illuminating a second region of the article with a second ultraviolet light exposure different from the first ultraviolet light exposure to photochemically crosslink the photochemically crosslinkable polymer composition, thereby creating a second crosslinked polymer having a second shape memory critical temperature.

One embodiment is a method of forming a photo-tailored shape memory article, comprising: forming an article comprising a photochemically crosslinkable polymer composition; wherein the photochemically crosslinkable polymer composition comprises a polycaprolactone di(meth)acrylate, pentaerythritol tetra(3-mercaptopropionate), and benzophenone; illuminating a first region of the article with a first ultraviolet light exposure to photochemically crosslink the photochemically crosslinkable polymer composition, thereby creating a first crosslinked polymer having a first shape memory critical temperature; and illuminating a second region of the article with a second ultraviolet light exposure different from the first ultraviolet light exposure to photochemically crosslink the photochemically crosslinkable polymer composition, thereby creating a second crosslinked polymer having a second shape memory critical temperature.

One embodiment is a method of programming a photo-tailored shape memory article, comprising: heating an article comprising a first photochemically crosslinked polymer composition having a first shape memory critical temperature, and a second photochemically crosslinked polymer composition spatially separated from the first photochemically crosslinked polymer composition and having a second shape memory critical temperature to a temperature greater than the first shape memory critical temperature and the second shape memory critical temperature; wherein the first shape memory critical temperature and the second shape memory critical temperature are different; deforming the first photochemically crosslinked polymer to impress a first desired temporary shape, and deforming the second photochemically crosslinked polymer to impress a second desired temporary shape; and cooling the article to a temperature below the first shape memory critical temperature and the second shape memory critical temperature. In one embodiment, the first photochemically crosslinked polymer composition and the second photochemically crosslinked polymer composition are contiguous, seamlessly connected, and prepared by differential photochemical crosslinlcing of adjacent sections of an article comprising a photochemically crosslinkable polymer composition. In some embodiments, the first shape memory critical temperature and the second shape memory critical temperature differ by about 1 to about 20° C.

Embossing may be used to form the temporary shape of any region of the article. Thus, deforming the first photochemically crosslinked polymer and deforming the second photochemically crosslinked polymer may, optionally, comprise embossing the article. In some embodiments embossing the article comprises embossing a pattern having wavelength in at least one dimension of about 350 to about 750 nanometers. Within this range, the wavelength may be at least about 400 nanometers, or up to about 700 nanometers. Techniques for embossing surfaces with features with visible wavelength patterns are described, for example, in D. Jun, Y. M. Lee, Y. Lee, N. H. Kim, K. Kim, and J.-K. Lee, “Facile fabrication of large area nanostructures for efficient surface-enhanced Raman scattering”, Journal of Materials Chemistry, 2006, volume 16, pages 3145-3149.

Embossing may be used to form the permanent shape of any region of the article. Thus, in some embodiments, the article has a permanent shape comprising an embossed region having embossed features, and deforming the first photochemically crosslinked polymer and deforming the second photochemically crosslinked polymer comprise compressing the embossed region of the article to form a temporary shape lacking the embossed features. Permanent embossed features may be formed during photo-tailoring.

Other embodiments include photo-tailored shape memory articles and programmed, photo-tailored shape memory articles prepared by any of the above-described methods. The photo-tailored shape memory articles are useful in a variety of product applications, including orthodontic applications (such as, for example, brackets, hooks, and caps), ophthalmic applications (such as, for example, intraocular lenses and contact lenses), and time-integrating temperature sensing for packaging, among others.

The photo-tailored shape memory article may be a sensor for determining whether any of a plurality of predetermined temperatures have been exceeded, comprising: a photo-tailored shape memory sensor comprising a plurality of photochemically crosslinked polymer compositions; wherein each photochemically crosslinked polymer composition is the product of photochemically crosslinking the same photochemically crosslinkable composition, and each photochemically crosslinked polymer composition varies from at least one other in the extent of crosslinking; wherein each photochemically crosslinked polymer composition has a known shape memory critical temperature; and wherein each photochemically crosslinked composition is embossed with a temporary shape indicative of its known shape memory critical temperature. As used herein, the term “plurality” means at least two. In this embodiment, the sensory has a permanent shape with a featureless region, and visible indicia are created by embossing to form the temporary shape on the featureless region. For example, the embossings could be series of temperature values, and the lowest visible temperature value visible after exposure would indicate the upper limit of temperature exposure.

In another embodiment, the shape memory article may be a sensor for determining whether any of a plurality of predetermined temperatures have been exceeded, comprising: a photo-tailored shape memory sensor comprising a plurality of photochemically crosslinked polymer compositions; wherein each photochemically crosslinked polymer composition is the product of photochemically crosslinking the same photochemically crosslinkable composition, and each photochemically crosslinked polymer composition varies from all of the others in the extent of crosslinking; wherein each photochemically crosslinked polymer composition has a known shape memory critical temperature; wherein each photochemically crosslinked composition is embossed with a permanent shape indicative of its known shape memory critical temperature; and wherein each photochemically crosslinked composition has a temporary shape different from the embossed permanent shape. In this embodiment, the permanent, embossed shape is formed during photochemical crosslinking. On exposure to a temperature greater than or equal to its shape memory critical temperature, each photochemically crosslinked polymer composition assumes a permanent shape in which the embossed permanent shape is present. For example, the embossings could be series of temperature values, and the highest visible temperature value visible after exposure would indicate the upper limit of temperature exposure.

One embodiment is a crosslinked polymer network, comprising the product of photochemically crosslinking a composition comprising: a polycaprolactone di(meth)acrylate macromer, a multifunctional thiol, and a photoinitiator. The polycaprolactone di(meth)acrylate macromer may have the structure 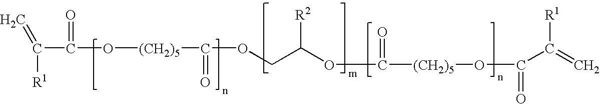
wherein each occurrence of R¹ and R² is independently hydrogen or methyl, m is 1 to about 10, and each occurrence of n is 1 to about 20 provided that the sum of both occurrences of n is at least 4, specifically at least 10. In some embodiments, each occurrence of R¹ and of R² is hydrogen, and m is 2. The polycaprolactone di(methacrylate) may be prepared by reaction of (meth)acryloyl chloride with a polycaprolactone diol, which is itself prepared by copolymerization of an alkylene glycol or polyalkylene glycol with ε-caprolactone. In some embodiments, the multifunctional thiol is selected from the group consisting of pentaerythritol tetramercaptopropionate, pentaerythritol tetramercaptoacetate, pentaerythritol tetrathioglycolate, trimethylolpropane trimercaptoacetate, trimethylolpropane trimercaptopropionate, 1,2,3-propanetrithiol, 1,2,6-hexanetrithiol, and mixtures thereof. In some embodiments, the multifunctional thiol is pentaerythritol tetramercaptopropionate.

One embodiment is a crosslinked polymer network, comprising repeating units having the structure 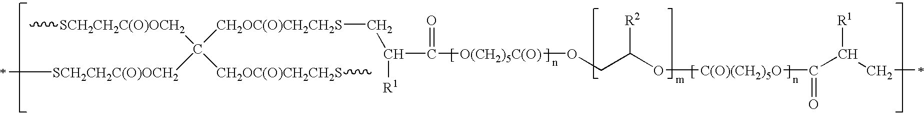
wherein each occurrence of R¹ and R² is independently hydrogen or methyl; each occurrence of m is independently 1 to about 10; each occurrence of n is independently 1 to about 20; and each wavy bond is a bond either to a hydrogen atom or another polycaprolactone di(meth)acrylate unit. In some embodiments, the crosslinked polymer network of claim 39, wherein m is 2, and each occurrence of R¹ and R² is hydrogen.

Another embodiment is a crosslinked polymer network, comprising the product of photochemically crosslinking a composition comprising: a telechelic polymer selected from the group consisting of di(meth)acrylate esters of polyhedral oligosilsesquioxane diol-initiated poly(ε-caprolactone)s, di(meth)acrylate esters of polyhedral oligosilsesquioxane diol-initiated polylactide-polyglycolide random copolymers, and di(meth)acrylate esters of poly(ethylene oxide)s; a multifunctional thiol, and a photoinitiator. In some embodiments, the telechelic polymer is a di(meth)acrylate ester of a polyhedral oligosilsesquioxane diol-initiated polylactide-polyglycolide random copolymer; wherein the crosslinked polymer network exhibits two thermally-induced shape memory transitions, each in the temperature range of about 25° C. to about 120° C.; and wherein the two thermally-induced shape memory transitions are separated by at least 10° C., specifically at least 20° C., more specifically at least 30° C., even more specifically at least 40° C., still more specifically at least 50° C., yet more specifically at least 60° C. In some embodiments, the multifunctional thiol is selected from the group consisting of pentaerythritol tetramercaptopropionate, pentaerythritol tetramercaptoacetate, pentaerythritol tetrathioglycolate, trimethylolpropane trimercaptoacetate, trimethylolpropane trimercaptopropionate, 1,2,3-propanetrithiol, 1,2,6-hexanetrithiol, and mixtures thereof. In some embodiments, the multifunctional thiol is pentaerythritol tetramercaptopropionate.

The invention includes certain novel telechelic polymers used to prepare the crosslinked polymer networks, as well as their precursor diols. Thus, one embodiment is a polyhedral oligosilsesquioxane diol-initiated poly(ε-caprolactone) having the structure 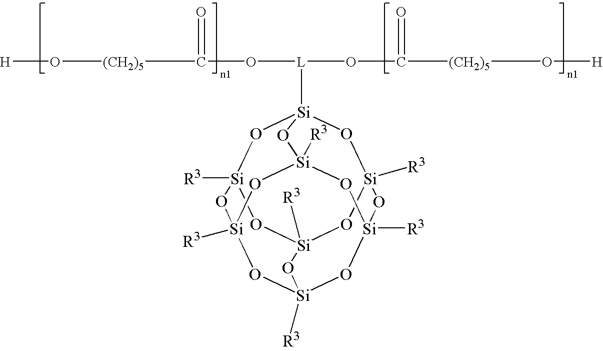
wherein each occurrence of R³ is independently optionally substituted C₁-C₁₂ hydrocarbyl, L is an optionally substituted C₂-C₂₄ trivalent hydrocarbyl linking group, and each occurrence of n1 is independently 1 to 30, specifically 2 to 20, provided that the sum of both occurrences of n1 is at least 4.

Another embodiment is a polyhedral oligosilsesquioxane diol-initiated poly(ε-caprolactone) di(meth)acrylate having the structure 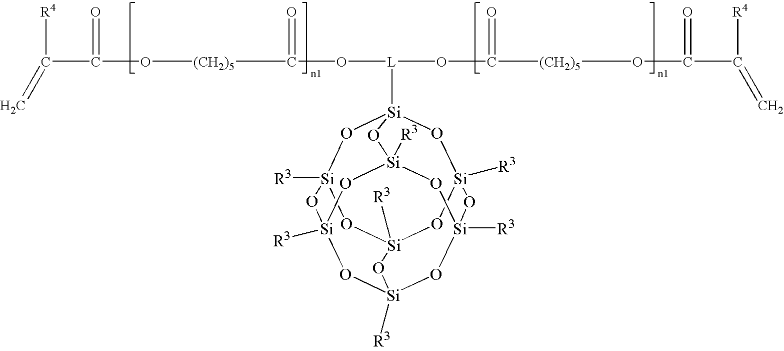
wherein each occurrence of R³ is independently optionally substituted C₁-C₁₂ hydrocarbyl, each occurrence of R⁴ is independently hydrogen or methyl, L is an optionally substituted C₂-C₂₄ trivalent hydrocarbyl linking group, and each occurrence of n1 is independently 1 to 30, specifically 2 to 20, provided that the sum of both occurrences of n1 is at least 4.

Another embodiment is a polyhedral oligosilsesquioxane diol-initiated poly(d,1-lactide-co-glycolide) diol having the structure 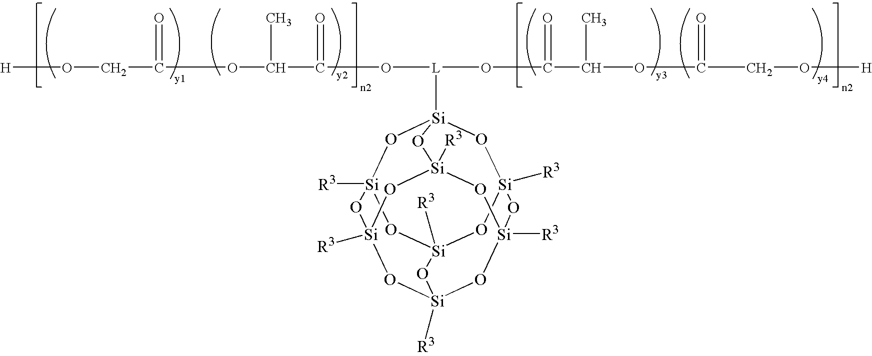
wherein each occurrence of R³ is independently optionally substituted C₁-C₁₂ hydrocarbyl, L is an optionally substituted C₂-C₂₄ trivalent hydrocarbyl linking group, each occurrence of y1, y2, y3, and y4 is independently 0.1 to 0.9, specifically 0.2 to 0.8, more specifically 0.4 to 0.6, provided that the sum of y1 and y2 is 1 and the sum of y3 and y4is 1, and each occurrence of n2 is independently 1 to 30, specifically 2 to 20, provided that the sum of both occurrences of n2 is at least 4.

Another embodiment is a polyhedral oligosilsesquioxane diol-initiated poly(d,1-lactide-co-glycolide) di(meth)acrylate having the structure 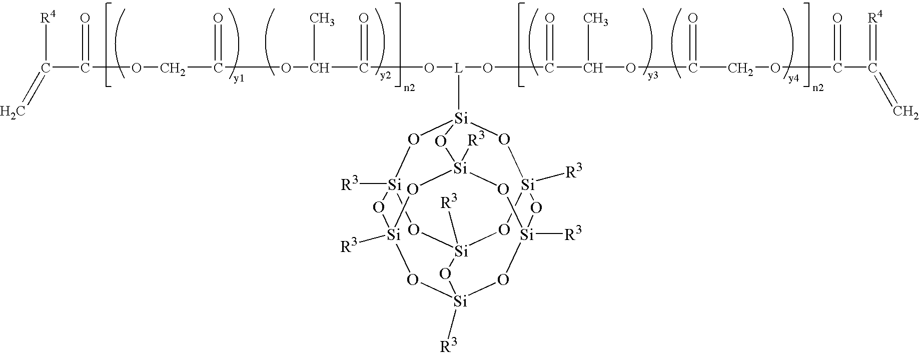
wherein each occurrence of R³ is independently optionally substituted C₁-C₁₂ hydrocarbyl, each occurrence of R⁴ is independently hydrogen or methyl, L is an optionally substituted C₂-C₂₄ trivalent hydrocarbyl linking group, each occurrence of y1, y2, y3, and y4 is independently 0.1 to 0.9, specifically 0.2 to 0.8, more specifically 0.4 to 0.6, provided that the sum of y1 and y2 is 1 and the sum of y3 and y4is 1, and each occurrence of n2 is independently 1 to 30, specifically 2 to 20, provided that the sum of both occurrences of n2 is at least 4.

The invention is further illustrated by the following non-limiting examples.

### EXAMPLES 1-8

Photochemically crosslinkable polymer compositions were purchased as NOA 63 and NOA 64 from Norland Products. NOA 63 is marketed for use as an optical adhesive and is described by its manufacturer as a clear, colorless, UV-curable liquid photopolymer. NOA 63 is believed to contain an allyl ether end-capped polyurethane, pentaerythritol tetra(3-mercaptoprionate) crosslinker, and benzophenone photoinitiator.

For Examples 1-3, a layer of NOA 63 about 1.5 millimeters thick was cured for various times between quartz plates with 356 nanometer ultraviolet light produced by a high intensity ultraviolet lamp obtained as Model SB-100P from Spectronics Corporation. In all cases, the distance between the lamp and the sample was 15 centimeters. Differential scanning calorimetry (DSC) analysis of the cured films indicated that curing times of 1, 2, and 3 hours each produced a cured film with a glass transition temperature (T_{g}) of 31° C. All DSC runs were carried out under nitrogen atmosphere at a scanning rate of 10° C./minute under nitrogen atmosphere using a TA Instruments Differential Scanning Calorimeter Q00.

For Examples 4-8, boron nitride was added to NOA 63 to produce compositions having 0.5, 1, 2.5, 5, and 10 weight percent boron nitride, respectively. Samples were photocured for three hours using the irradiation conditions described for examples 1-3. Results of DSC analysis of the cured samples are given in Table 1. The results show a modest increase in T_{g} with increasing boron nitride concentration.

TABLE 1

| | Boron Nitride | |
|---|---|---|
| | Concentration | |
| Ex. No. | (weight percent) | T_{g} (° C.) |
| 4 | 0.5 | 32.0 |
| 5 | 1.0 | 32.5 |
| 6 | 2.5 | 33.8 |
| 7 | 5.0 | 33.0 |
| 8 | 10.0 | 35.2 |

### EXAMPLES 9-15

The procedure of Examples 1-3 was followed except that the distance he UV lamp and the sample was decreased to 5 centimeters, and the curing incrementally varied from 0 (uncured NOA 63) to 3.5 hours. DSC results, able 2, indicate that variations in photochemical curing time can be used to of the cured material from about 30 to about 47° C.

TABLE 2

| | UV Exposure | |
|---|---|---|
| Ex. No. | Time (minutes) | T_{g} (° C.) |
| 9 | 0 | −60 |
| 10 | 5 | 30 |
| 11 | 30 | 35 |
| 12 | 60 | 42 |
| 13 | 120 | 47 |
| 14 | 180 | 46 |
| 15 | 210 | 46 |

### EXAMPLES 6-19

The procedure of Examples 9-15 was followed except that the curable composition contained 5 weight percent of boron nitride based on the total weight of the composition. DSC results, given in Table 3, indicate that curing time can be used to vary the T_{g} of the boron nitride-filled, cured material from about 23 to about 47° C.

TABLE 3

| | UV Exposure | |
|---|---|---|
| Ex. No. | Time (minutes) | T_{g} (° C.) |
| 16 | 0 | −60 |
| 17 | 5 | 23 |
| 18 | 60 | 40 |
| 19 | 180 | 47 |

### EXAMPLE 20

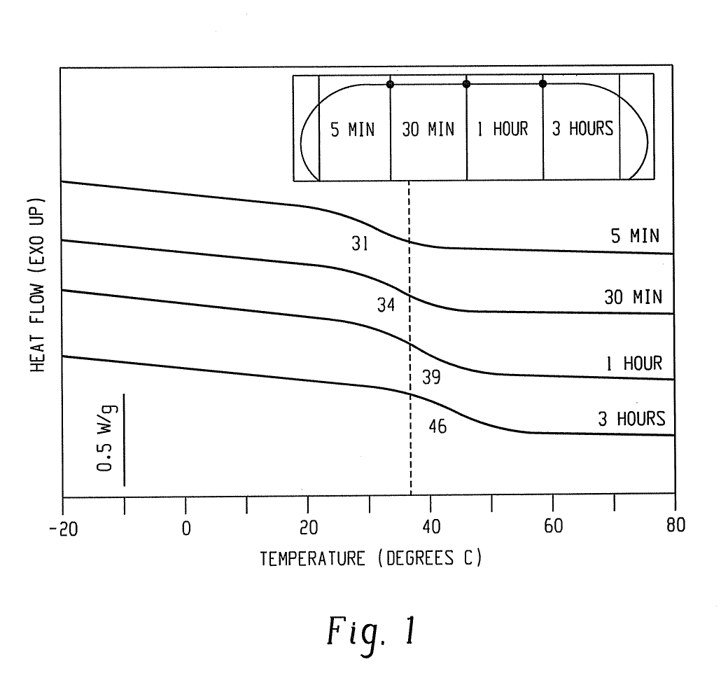

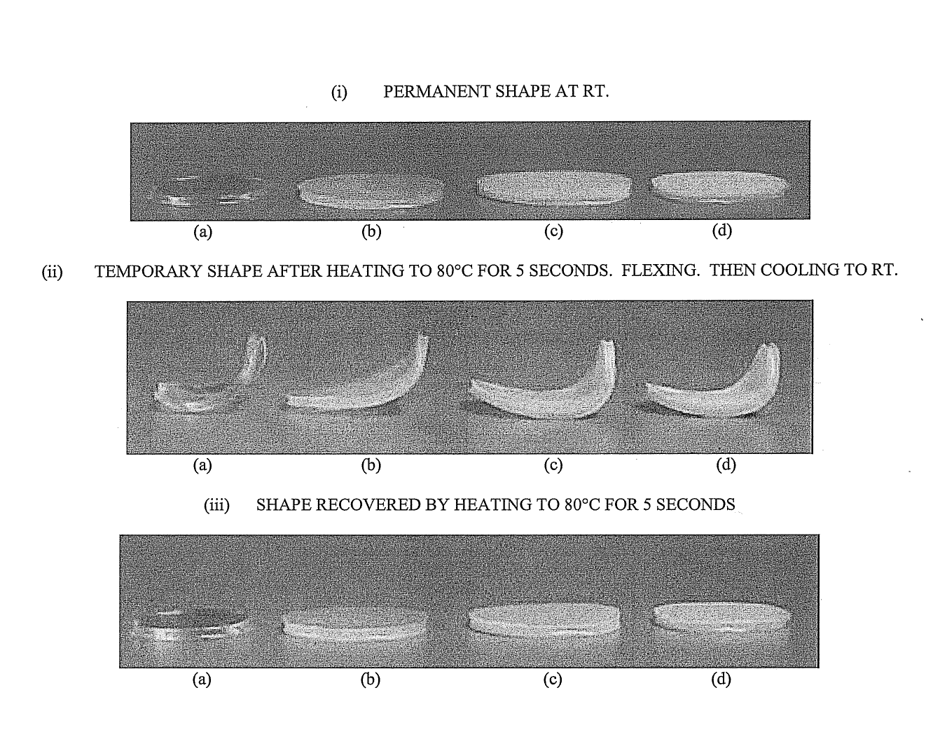

A unique feature of photo-tailored shape memory polymers is their ability to create seamless monoliths with smooth or discrete variation in shape memory critical temperature (T_{crit}). This concept was demonstrated by curing different segments of a single NOA 63 film for times of 3 hours, one hour, 30 minutes, and 5 minutes by withdrawing a mask from right to left along the length of the sheet. FIG. 1 includes an inset image of the differentially photocured article and shows DSC curves for its four segments. The DSC results, presented in Table 4, illustrate that different segments of the same article were photo-tailored to have T_{g} values varying gradually and discretely over a 16° C. range (i.e., from 31 to 46° C.). Similarly, gradual and continuous variation in T_{g} within a single article can be obtained by continuously varying the exposure time (e.g., by continuously removing a mask from the surface of the article during UV curing).

TABLE 4

| UV Exposure | |
|---|---|
| Time (minutes) | T_{g} (° C.) |
| 5 | 31 |
| 30 | 34 |
| 60 | 39 |
| 180 | 46 |

### EXAMPLES 21-26

To illustrate possible application of the present materials to dental and orthodontic devices, the translucency of NOA 63 was altered by adding a filler. Six samples containing 0, 0.5, 1, 2.5, 5, and 10 weight percent boron nitride in NOA 63 were prepared and cured according to the procedure of Examples 4-8. The cured compositions were smooth, bubble-free films. The samples with 2.5 to 10 weight percent boron nitride were tooth-like in appearance. The boron nitride filler also has the advantage of increasing the thermal conductivity of the composition, which is useful is speeding the transition from a temporary shape to a permanent shape.

To qualitatively assess the shape memory behavior in the new materials, ovoid discs corresponding to Examples 23-26 (1, 2.5, 5, and 10 weight percent boron nitride, respectively) were: (i) photographed in their equilibrium (stress-free) states at room temperature, (ii) heated to 80° C., bent into a temporary shape, cooled to room temperature, then photographed, and (iii) heated to 80° C. where their equilibrium shapes were observed to recover, then photographed. FIG. 2 shows the corresponding photographic images, revealing that the quality of fixing and recovery is high for all of the samples tested. In FIG. 2, images labeled (a)-(d) corresponding to Examples 23-26, respectively.

### EXAMPLE 27

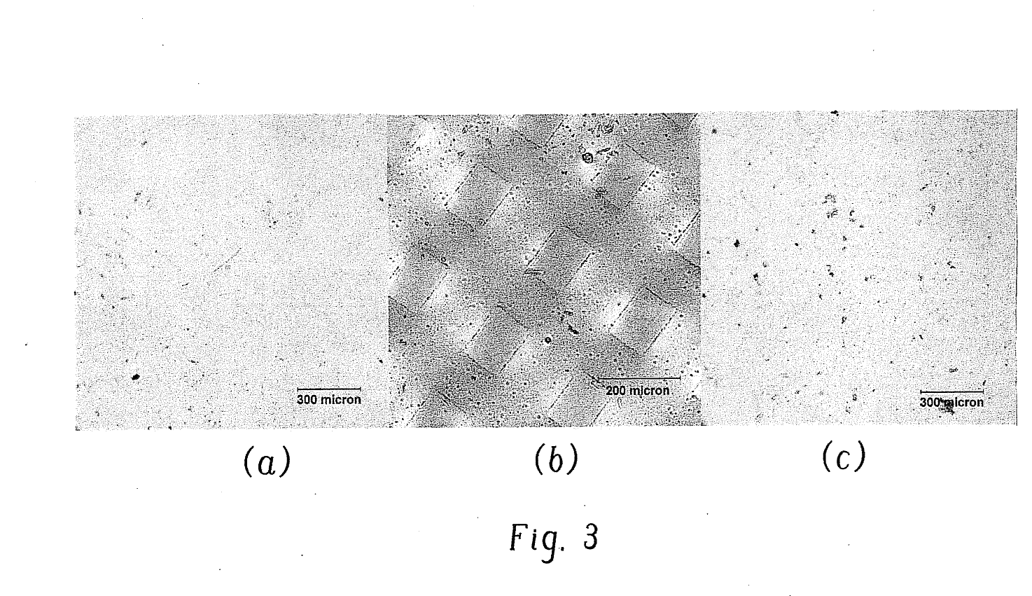

The photo-tailored shape memory articles may be reversibly embossed. A cured film of NOA 63 was prepared according to the method of Example 14. The sample was (a) photographed at room temperature before embossing, (b) heated to 70° C. and embossed at that temperature with two kilograms force for five seconds, cooled to room temperature, and photographed, and (c) heated to 70° C. at which temperature de-embossing occurred, and photographed. The embossed pattern disappeared within 10 seconds at 70° C. The corresponding photographic images, shown in FIG. 3, illustrate this process and show the full recovery (loss of embossing) after heating to 70° C. Images (a) and (c) in FIG. 3 correspond to 100x magnification, and image (b) corresponds to 200× magnification.

If a pattern were embossed on a photo-tailored shape memory article featuring a linear spatial gradient of T_{g}, inspection of the recovery “front” would reveal the highest temperature the sample had experienced since the embossed pattern was fixed. A colorful embossing pattern (i.e., one with a pattern wavelength in the 300-700 nm range) would be simple to read visually or with a color imaging device (e.g., a charge-coupled device (CCD) camera).

### EXAMPLE 28

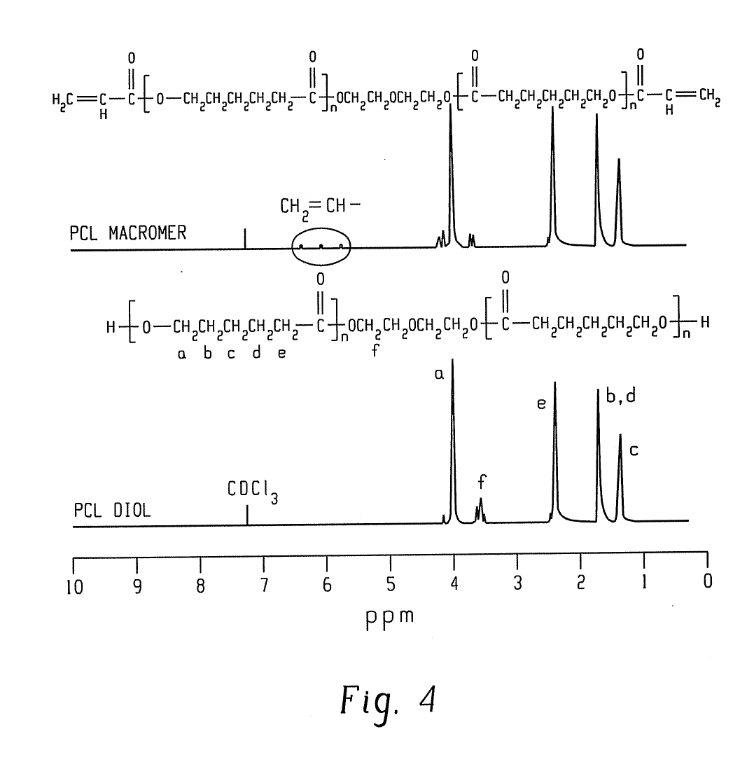

This example describes preparation and testing of polycaprolactone network formed by photopolymerization. A polycaprolactone diol (“PCL diol”; a copolymer of epsilon-caprolactone and diethylene glycol; CAS Registry No. 36890-68-3) having a number average molecular weight of about 2,000 atomic mass units was purchased from Aldrich and used as received. A polycaprolactone macromer (“PCL macromer”) was prepared by reacting the PCL diol (8 grams, 4 millimoles) with acryloyl chloride (0.76 milliliters, 9 millimoles) in benzene solvent (80 milliliters) in the presence of triethylamine catalyst (1.26 milliliters, 9 millimoles) at 80° C. for three hours. The reaction mixture was filtered to remove the byproduct (triethylamine hydrochloride) and then PCL macromer was isolated by dripping the filtrate into n-hexane. The precipitated PCL macromer was dried at 45° C. for 24 hours in vacuum oven, and the yield was higher than 95%. ¹H NMR spectra of the PCL diol and PCL macromer are presented in FIG. 4.

A polycaprolactone network (“PCL network”) was prepared by photopolymerizing the PCL macromer with pentaerythritol tetra(3-mercaptoprionate) crosslinker in the presence of a photoinitiator. Specifically, a viscous mixture of PCL macromer (0.5 gram, 0.25 millimole) and tetra-thiol (0.09 milliliter, 0.25 millimole) was diluted with 1 milliliter of methylene chloride, then 2,2-dimethoxy-2-phenylaceophenone photoinitiator (150 microliters of a solution containing 100 milligrams initiator per 1 milliliter of methylene chloride) was added, and the formulation was cured between glass slides or in vials by exposure to UV illumination (365 nanometers).

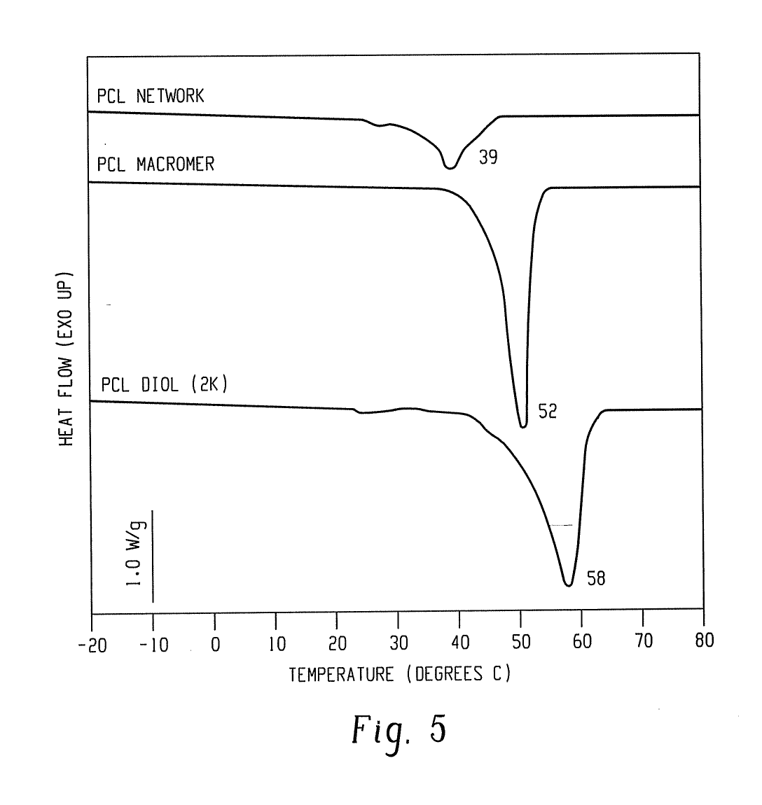

FIG. 5 shows the DSC results for the PCL diol, the PCL macromer, and the PCL network (PT-SMP). Melting temperatures of the PCL diol, the PCL macromer, and the PCL network are 58, 52, and 39° C., respectively. Heats of fusion for these materials are 97.6, 92.7, and 39.6 Joules/gram, respectively.

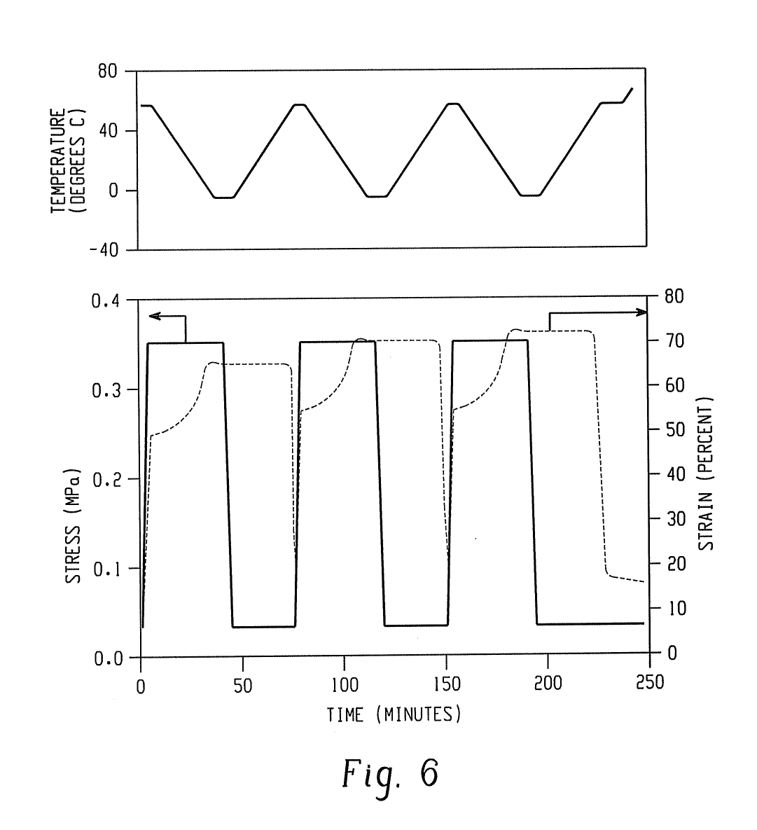

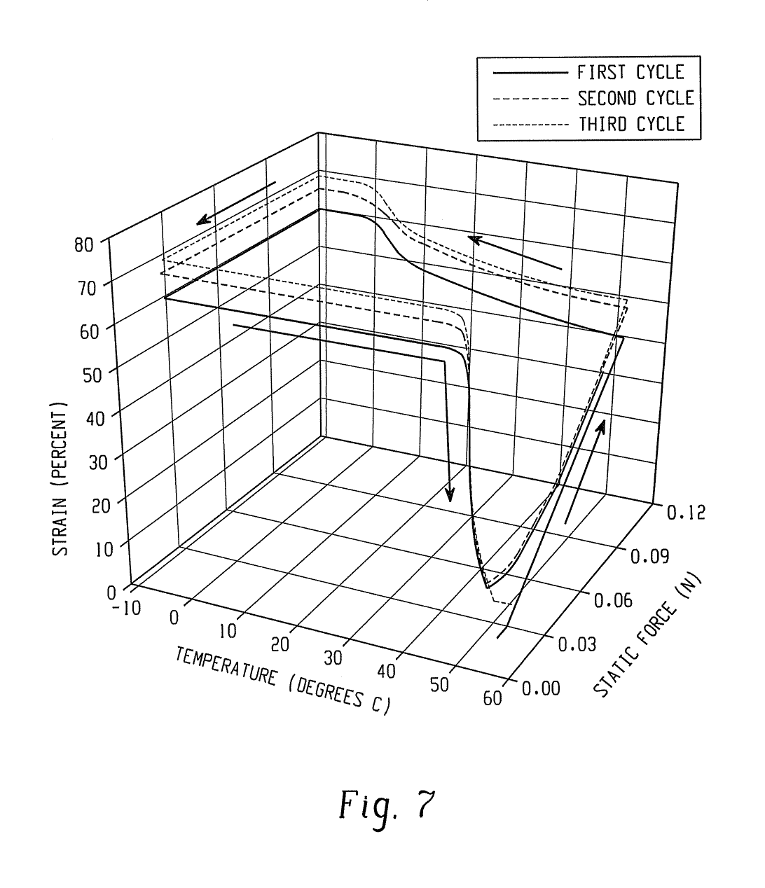

The PCL network exhibits excellent shape memory behavior. FIGS. 6 and 7 show the shape memory cycles of the PCL network. Note that melting temperature of PCL network was about 39° C. on heating and about 15° C. on cooling, influencing the critical temperature for recovery and the critical temperature for fixing, respectively. FIG. 6 shows the PCL network one-way shape memory cycles in repetition; excellent shape fixing and good shape recovery are observed. A sample of PCL network was cut to a straight bar having 5.7 millimeter length×0.6 millimeter width×0.47 millimeter thickness. This specimen was loaded in the tensile fixture of the DMA and heated to 56° C. under a small force of 0.01 Newton to keep this sample straight and then stretched at a constant rate of 0.025 Newton/minute to a force of 0.1 Newton followed by an isostress annealing step at the same temperature for 1 minute. This stretched specimen was then fixed by cooling to −5° C. at a cooling rate of 2° C./minute, and then held at this temperature for 5 minutes to ensure a uniform temperature distribution. The force was then reduced to the preload force of 0.01 Newton at a rate of 0.025 Newton/minute, revealing the level of strain fixing. Finally, shape recovery was examined by heating the specimen to 56° C. at a heating rate of 2° C./minute under the preload force of 0.01 Newton while monitoring the change of sample length. Three one-way shape memory cycles were performed for this PCL network sample shown in FIG. 6. FIG. 7 presents the same data in a 3D graph format.

### EXAMPLES 29 AND 30

These examples demonstrate the preparation and testing of two polyhedral oligosilsesquioxane-initiated poly(ε-caprolactone) diols (POSS-PCL diols), corresponding acrylate-terminated macromers, and thermoset networks.

The general reaction scheme for preparation of POSS-PCL diol, macromer, and thermoset is summarized in Scheme 1. Briefly, polymerization of ε-caprolactone (8.77 millimoles) was initiated with POSS diol (1 millimole, TMP (2,2,4-trimethyl-1,3-pentane) diol-isobutyl-POSS, Hybrid Plastics, Inc.) and conducted for 24 hours at 140° C. in the presence of the polymerization catalyst tin(II) 2-ethylhexanoate to produce a POSS-PCL-2K diol having a central POSS group and two PCL chains, each with a number average molecular weight of about 500 atomic mass units for a total molecular weight including the POSS group of 2,000 atomic mass units. This POSS-PCL-2K diol was precipitated into acetonitrile, filtered, and dried under vacuum at 50° C. for 24 hours. The POSS-PCL-2K diol (1 millimole) was reacted with acryloyl chloride (2.3 millimoles) in the presence of triethylamine catalyst (2.3 millimoles) in benzene (BZ) as a solvent) for 3 hours at 80° C. to yield the POSS-PCL-2K macromer. Triethylamine hydrochloride was filtered out, and POSS-PCL-2K macromer was precipitated in n-hexane and dried under vacuum. Photochemical reaction of the POSS-PCL-2K macromer (1 millimole) with pentaerythritol tetra(3-mercaptoprionate) crosslinker (0.5_millimole) in the presence of a photoinitiator (0.02 millimole, 2,2-Dimethoxy-2-phenyl-acetophenone, CAS Reg. No. 24650-42-8, Sigma-Aldrich) yielded the POSS-PCL-2K thermoset. Unreacted monomers were removed by methylene chloride and the residue was dried at 50° C. for 24 hours under vacuum. By increasing the molar ratio of ε-caprolactone to POSS diol, a POSS-PCL-2.5K diol having a central POSS group and two PCL chains each with a number average molecular weight of about 750 atomic mass units was prepared. Corresponding POSS-PCL-2.5K macromer and POSS-PCL-2.5K thermoset were also prepared.

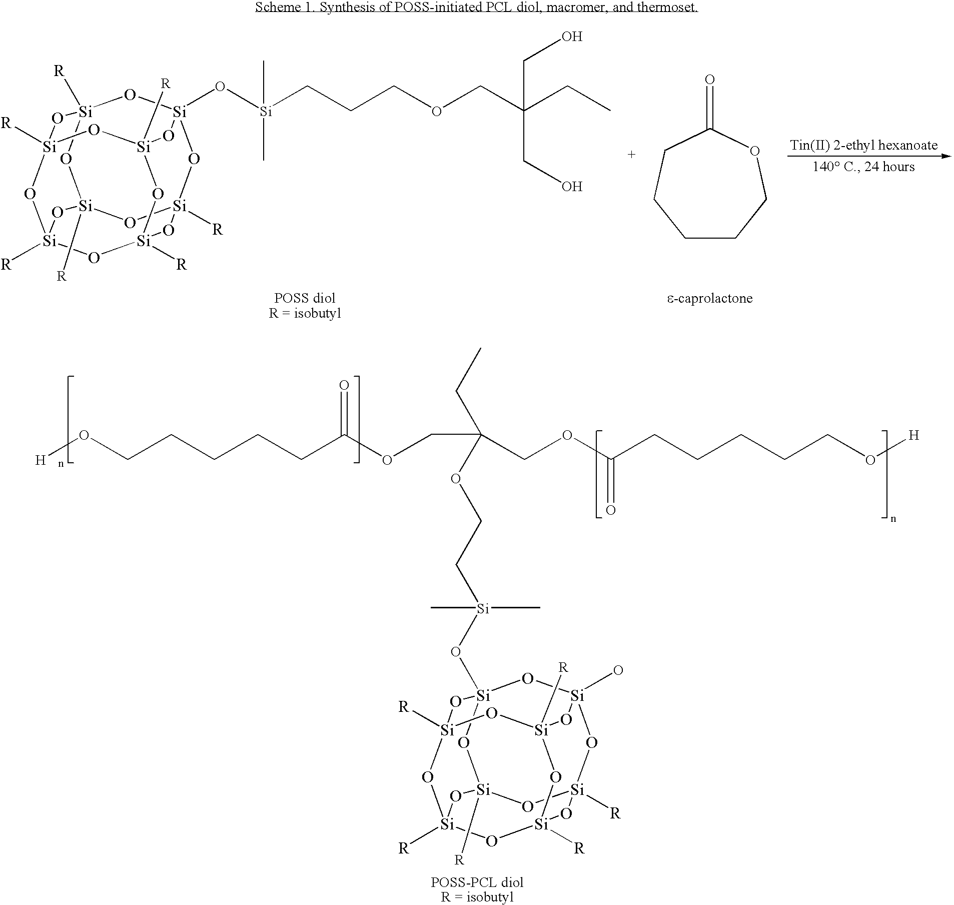

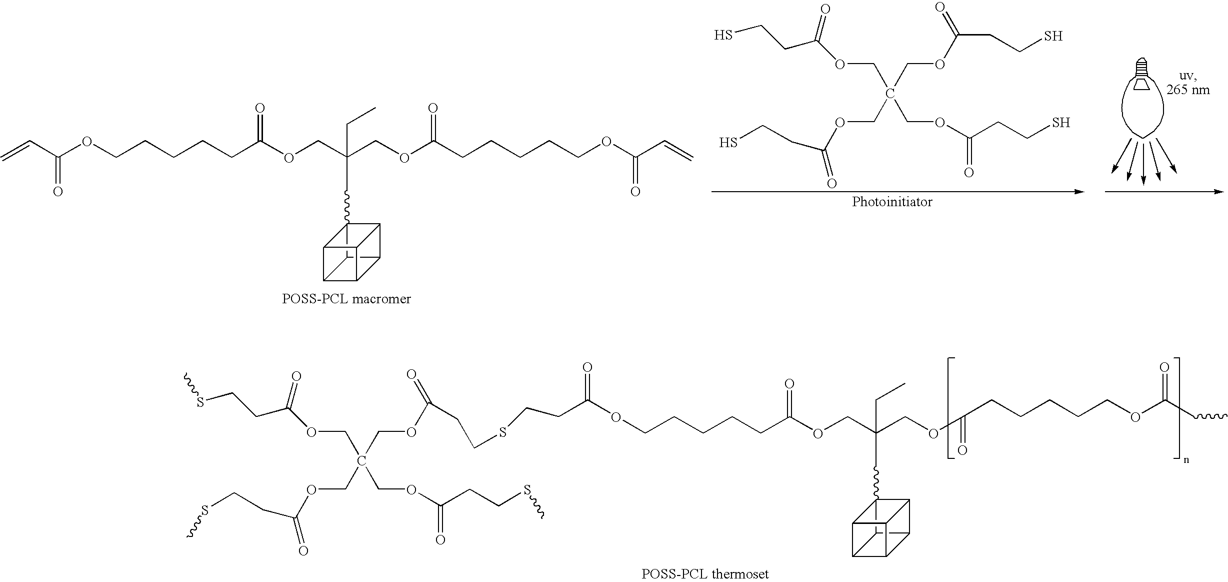

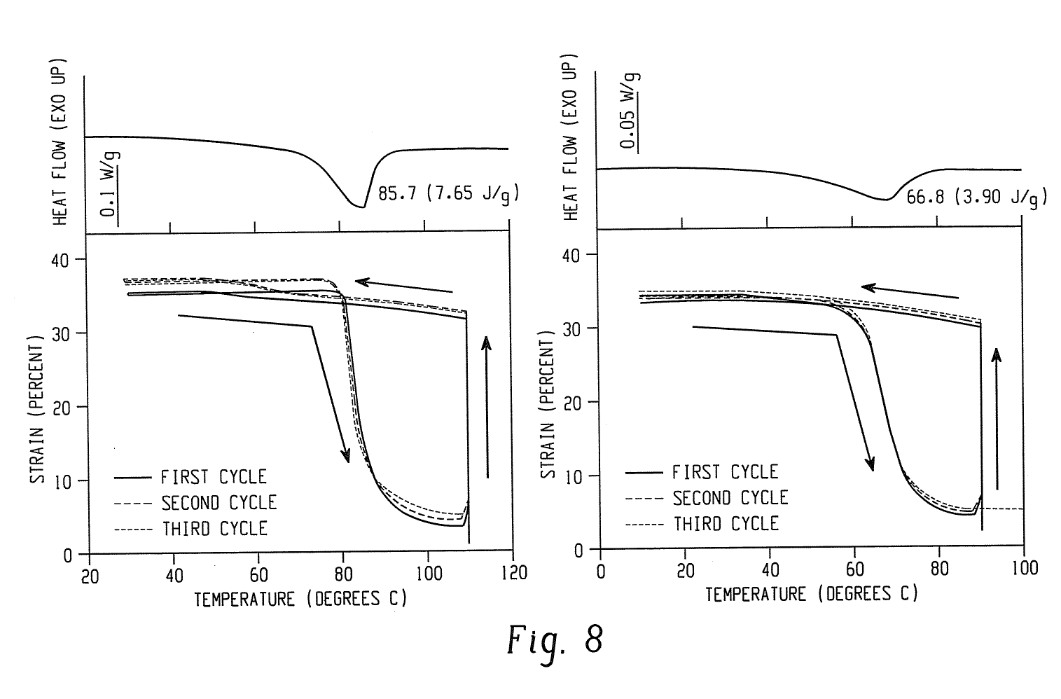

FIG. 8 shows three shape memory cycles for the POSS-PCL-2K thermoset network (left) and the POSS-PCL-2.5K thermoset network (right). High quality shape memory properties (shape fixing and shape recovery) are observed in both POSS-PCL-2K and POSS-PCL-2.5K networks. Note that the POSS moiety appears to suppress PCL crystallization but itself crystallizes (and melts), allowing one-way shape behavior around the POSS melting temperature. The POSS melting point depends on the length of the PCL chain, with higher POSS melting point being associated with lower PCL chain length. Specifically, the POSS-PCL-2K network exhibits a POSS melting point of 85.7° C., and the POSS-PCL-2.5K network exhibits a POSS melting point of 66.8° C.

### EXAMPLES 31-36

These examples demonstrate the preparation and testing of ethylene glycol-initiated poly(d,1-lactide-co-glycolide) diols and POSS diol-initiated poly(d,1-lactide-co-glycolide) diols, corresponding acrylate-terminated macromers, and thermoset networks.

The general synthetic scheme for ethylene glycol-initiated poly(d,1-lactide-co-glycolide) (PLGA) diol, macromer, and network is shown in Scheme 2. The mole ratio of lactide (LA) to glycolide (GA) was fixed at 50:50 (hence the designation PLGA50). The lactide and glycolide were copolymerized in the presence of ethylene glycol (EG) initiator, and tin (II) 2-ethylhexanoate catalyst for 24 hours at 140° C. to produce three PLGA50 diols having number average molecular weights of about 1,000, 2,000, and 4,000 atomic mass units. Acrylate-terminated monomers were prepared by reacting a PLGA50 diol with acryloyl chloride (AC) in the presence of triethylamine (TEA) catalyst and benzene (BZ) solvent at 80° C. for three hours. Thermoset networks were prepared by the photochemical reaction of PLGA50 macromer with pentaerythritol tetra(3-mercaptoprionate) crosslinker in the presence of a photoinitiator. The mole ratio of macromer to crosslinker (pentaerythritol tetra(3-mercaptoprionate)) for all PLGA50 networks was fixed at 1:0.5. POSS diol was substituted for ethylene glycol to prepare corresponding POSS-PLGA50 diols, macromers, and networks.

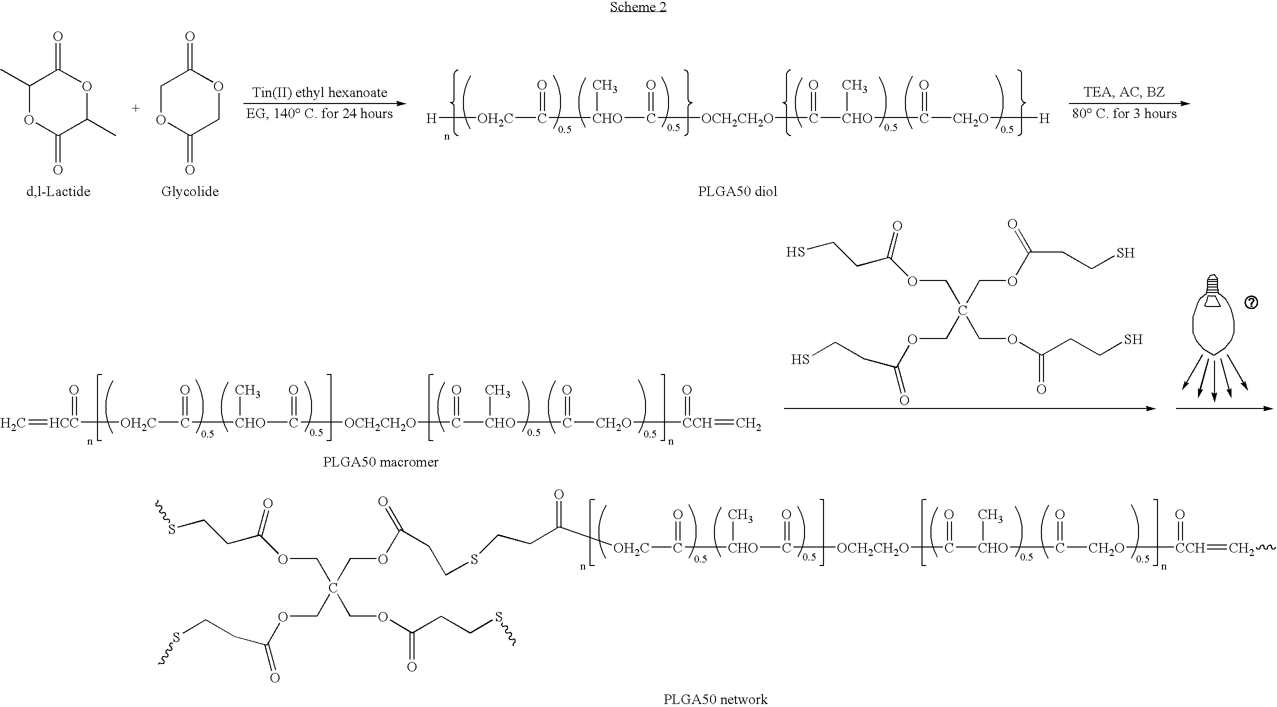

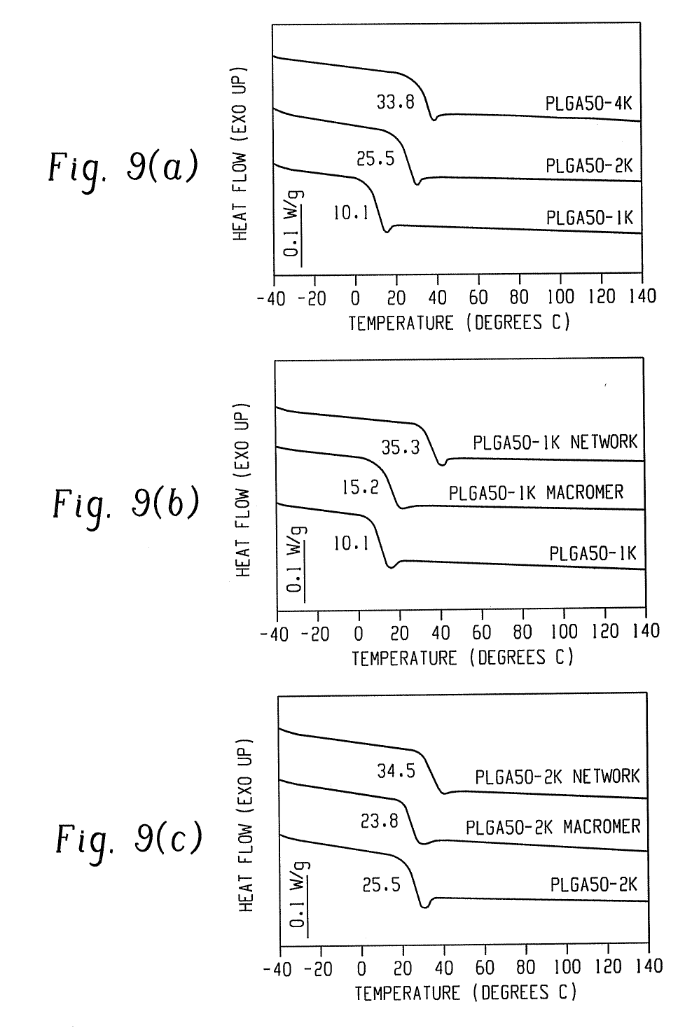

The DSC results for PLGA50 diol, macromer, and network are shown in FIG. 9. The glass transition temperature (T_{g}) for these PLGA50 diols increases with increasing molecular weight from 10.1° C. to 33.8° C. as shown in FIG. 9(a). FIGS. 9(b) and 9(c) exhibit the DSC results for the PLGA50-1K diol, PLGA50-1K macromer, PLGA50-1K network, PLGA50-2K, PLGA50-2K macromer, and PLGA50-2K network.

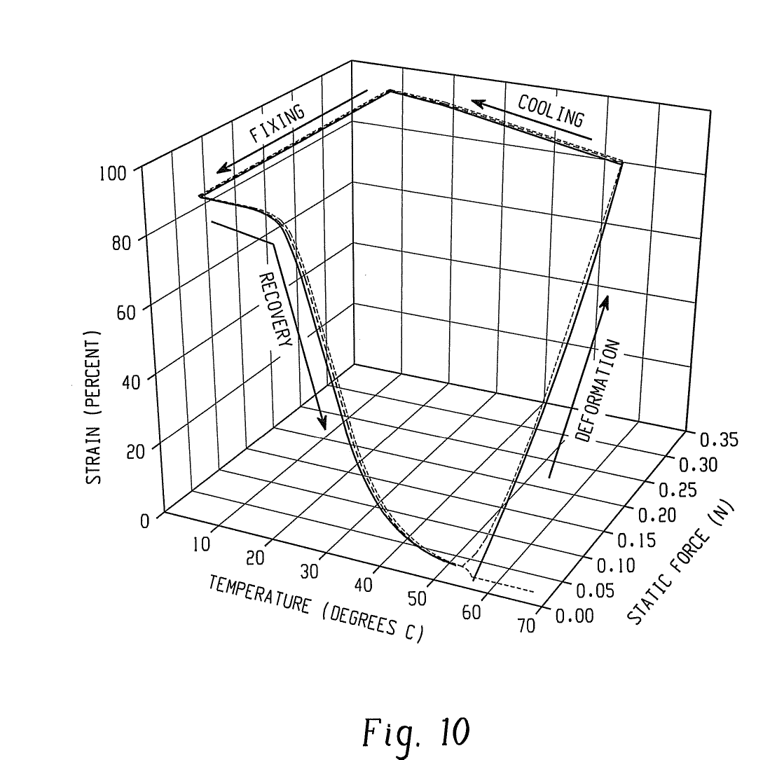

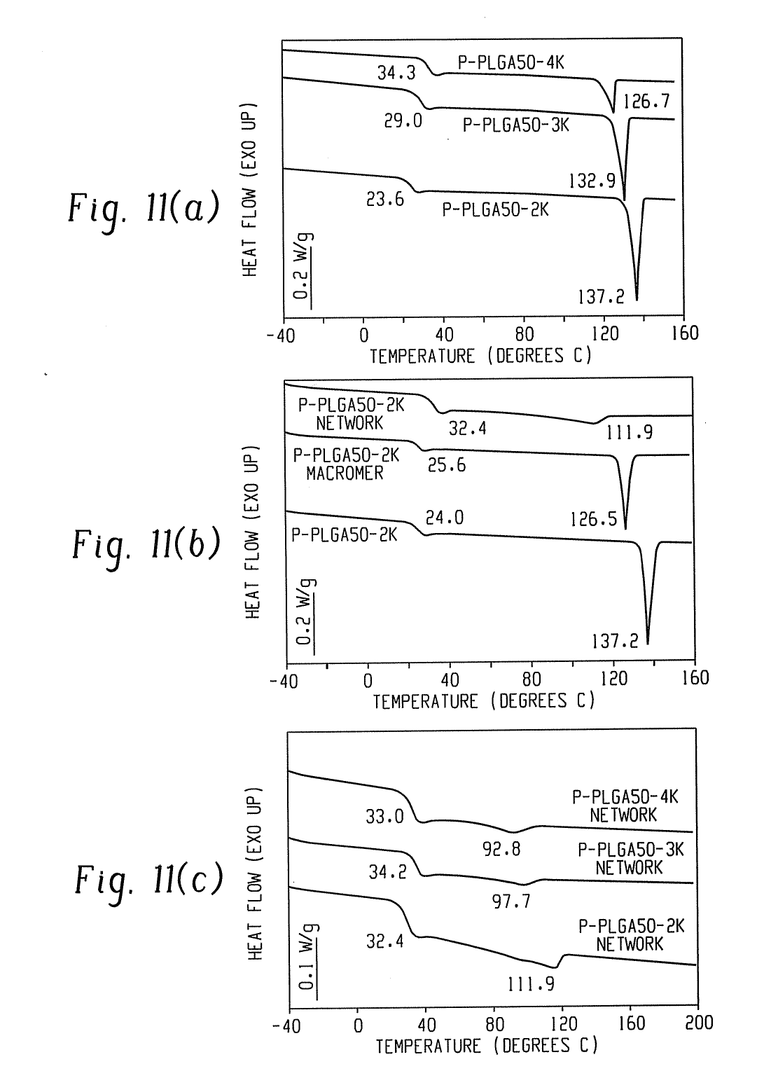

FIG. 10 shows three shape memory cycles for the PLGA50-2K network. These results demonstrate that the PLGA50-2K network exhibits high quality shape fixing and shape recovery.

Differential scanning calorimetry (DSC) results for POSS-initiated PLGA50 diols, macromers, and networks are shown in FIG. 11. Note that POSS contents in POSS-PLGA50-2K, POSS-PLGA50-3K, and POSS-PLGA50-4K diols are about 50%, 33%, and 25%, respectively. The POSS melting transition temperature (T_{m,POSS}) increases with increasing the POSS content in POSS-PLGA50 diols, whereas glass transition temperature from PLGA component decreases as shown in FIG. 11(a). The POSS-PLGA50-2K network shows increased T_{g} and decreased T_{m,POSS} compared to corresponding values for the POSS-PLGA50-2K diol as shown in FIG. 11(b). Transition temperatures for three POSS-PLGA50 networks are shown in FIG. 11(c). T_{m,POSS} increases with increasing POSS content in POSS-PLGA50 networks, however, T_{g} from PLGA component is more or less constant. Note that these POSS-PLGA50 networks show double network structure: one transition is associated with chemical crosslinlcing of the PLGA network, and the other transition is associated with physical crosslinking (POSS aggregation). So, these POSS-PLGA50 networks (and POSS-PCL networks) can be used for double fixing shape memory materials, which is important for developing new shape memory biomedical devices.

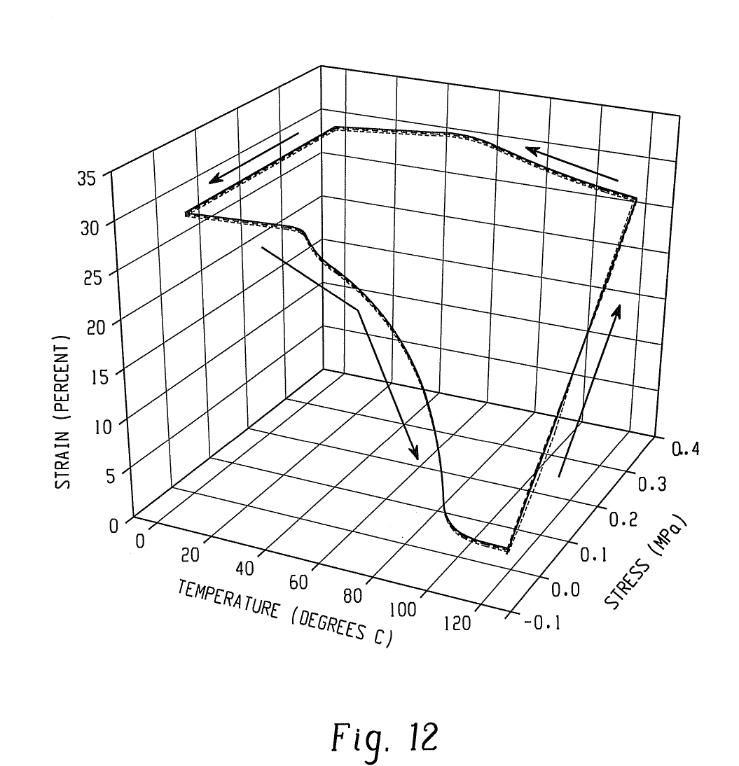

FIG. 12 exhibits three shape memory cycles for POSS-PLGA50-3K network. These results demonstrate that the POSS-PLGA networks exhibit high quality shape fixing and shape recovery.

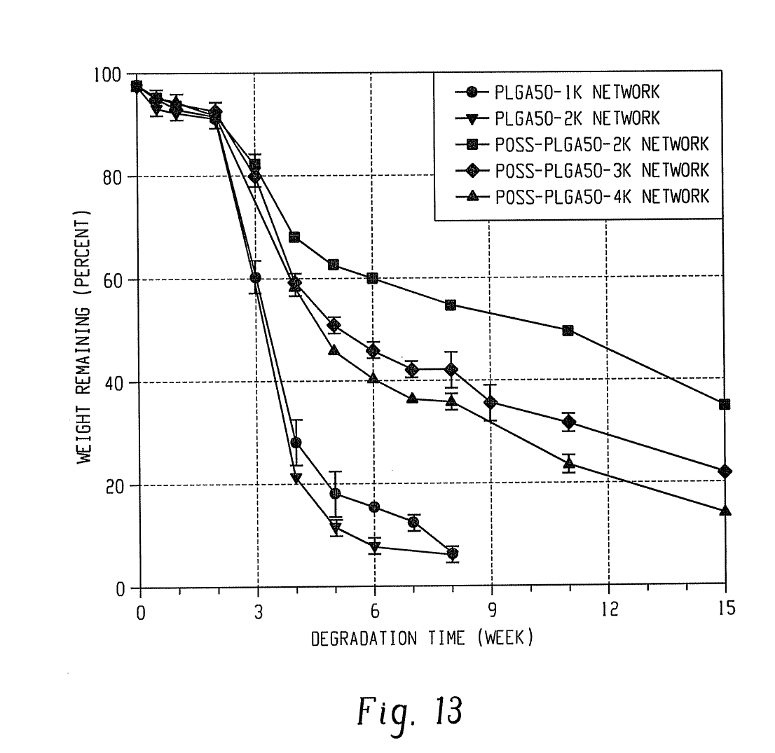

FIG. 13 shows the in vitro degradation of PLGA50 networks and POSS-PLGA50 networks in buffer solution with Tween-20 (a surfactant commonly used in such studies) at 37° C. The buffer solution contained phosphate (0.01M), sodium chloride (0.138 M), and potassium chloride (0.0027 M) and had a pH of 7.4 at 37° C. EG-initiated PLGA50 networks show major degradation within 4 to 6 weeks, whereas POSS-PLGA50 networks exhibit much slower degradation rates, because POSS-initiated PLGA50 polymers are more hydrophobic than EG initiated PLGA50 polymers. The POSS-PLGA50-2K network, which has a higher POSS content, exhibits slower degradation rate than the POSS-PLGA50-3K and POSS-PLGA50-4K networks. The POSS content in the POSS-PLGA50 networks plays an important role to control hydrophobicity/hydrophilicity of these networks.

Although photochemical crosslinking reactions were used in the above-described experiments, thermal curing can also be used to form the thermoset networks. For example, the PLGA and POSS-PLGA macromers can be blended with a thermal initiator (such as azoisobutyronitrile, AIBN), and optionally with a pharmaceutically active ingredient (such as paclitaxel), to form a thermally curable composition. The curable composition can be electrosprayed onto a metallic stent and thermally cured. Thermal curing may be preferable to photochemical curing when the curable composition comprises a photochemically sensitive pharmaceutical active.

### EXAMPLES 34-37

These examples demonstrate the preparation and testing of acrylate-terminated poly(ethylene oxide) macromers and corresponding thermoset networks.

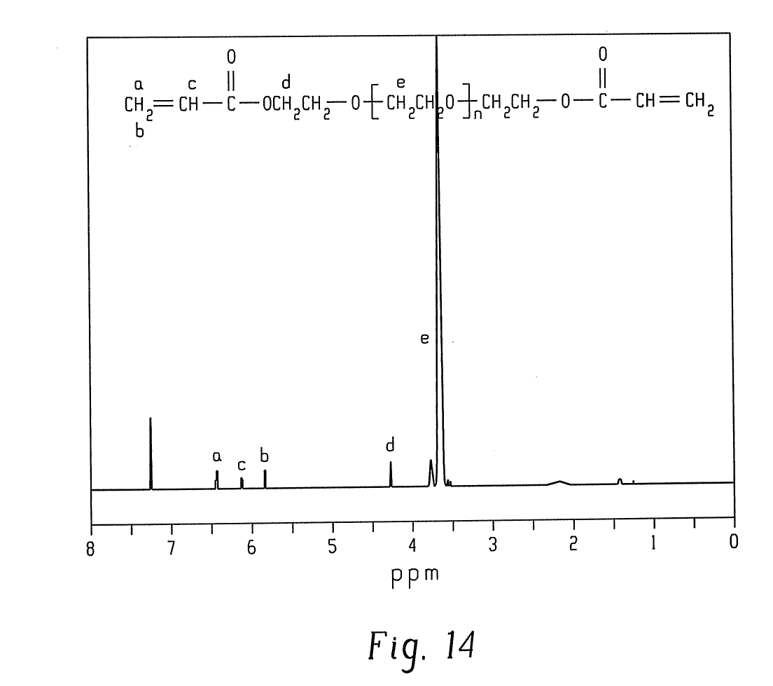

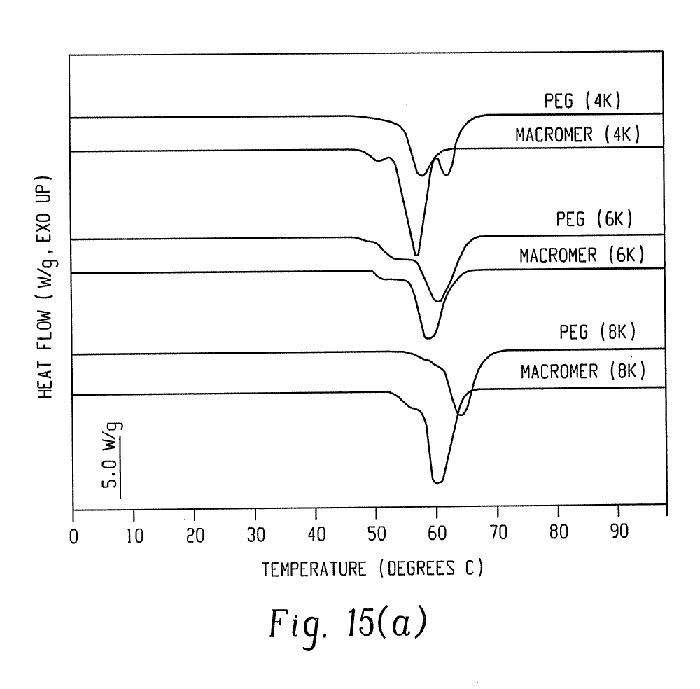

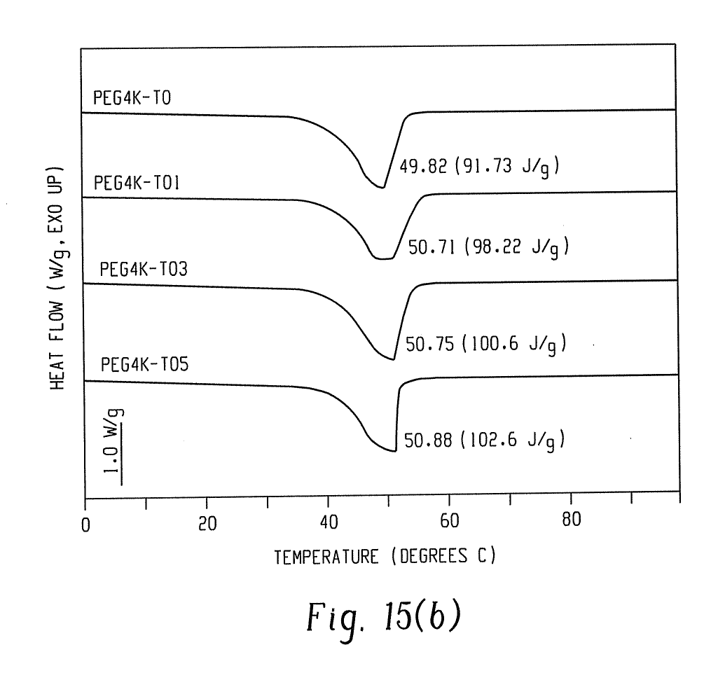

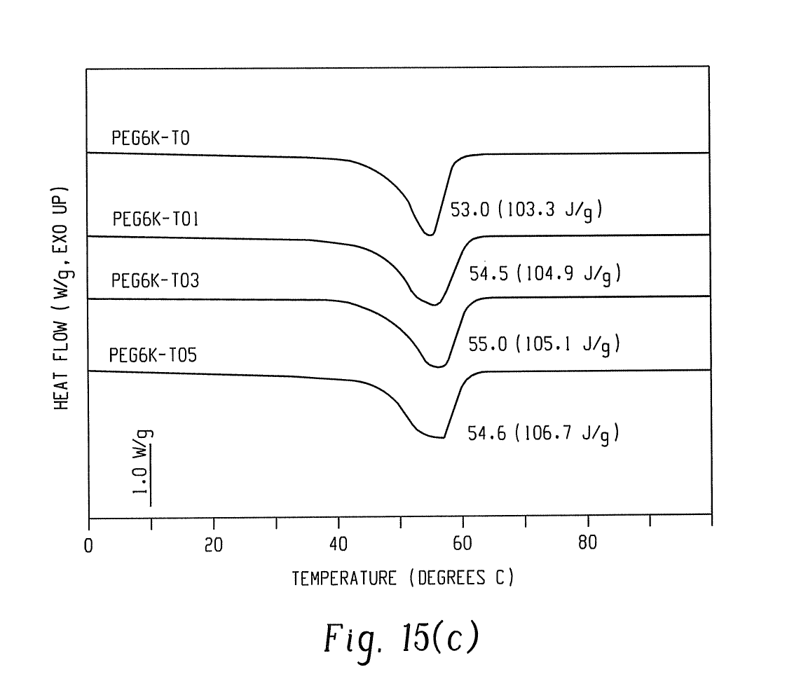

To synthesize the macromers, four commercially available poly(ethylene glycol)s having number average molecular weights of about 2,000, 4,000, 6,000, and 8,000 atomic mass units were endcapped with acrylate groups using the method described above. The resulting poly(ethylene glycol) (PEG) diacrylates were crosslinked with stoichiometric pentaerythritol tetra(3-mercaptoprionate) in the presence of a photoinitiator. FIG. 14 shows the ¹H NMR spectrum of the PEG-2K macromer, and all peaks are assigned. DSC results for PEG starting materials, macromers, and networks are shown in FIG. 15. The melting temperatures of PEG-4K, PEG-6K, and PEG-8K are all in the range of 60-64° C. All PEG macromers show slightly lower melting temperatures than the corresponding PEG starting materials. FIGS. 15(b) and 15(c) show melting transitions for PEG-4K and PEG-6K networks having different mole ratios of PEG to crosslinker; all the PEG networks exhibit similar melting transition temperatures.

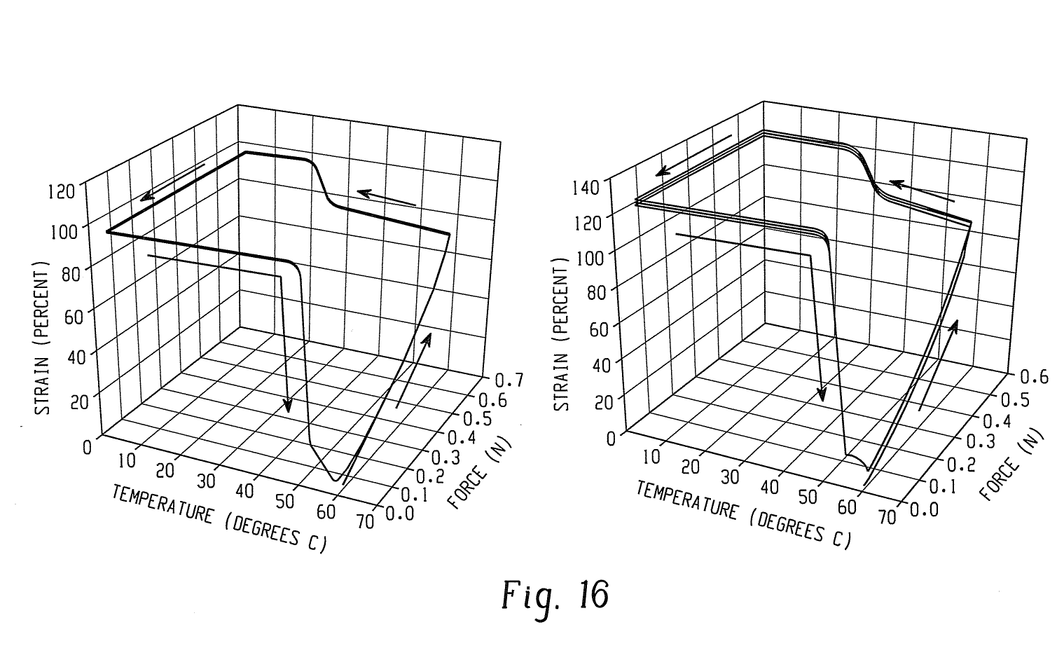

FIG. 16 shows three shape memory cycles for the PEG-6K and PEG-8K networks. These results demonstrate that the PEG networks exhibit high quality shape memory behavior.

While shape memory behavior has been thermally initiated in these experiments, it may also be possible to initiate such behavior with moisture (that is, by exposure to water in a liquid, gaseous, or vaporous state).

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A method of forming a photo-tailored shape memory article, comprising:
forming an article comprising a photochemically crosslinkable polymer composition;
illuminating a first region of the article with a first light exposure to photochemically crosslink the photochemically crosslinkable polymer composition, thereby creating a first crosslinked polymer having a first shape memory critical temperature; and
illuminating a second region of the article with a second light exposure different from the first light exposure to photochemically crosslink the photochemically crosslinkable polymer composition, thereby creating a second crosslinked polymer having a second shape memory critical temperature.

2. The method of claim 1, wherein said forming an article comprises using a method selected from the group consisting of liquid casting, solution casting, melt processing, film extrusion, sheet extrusion, injection molding, compression molding, blow molding, embossing, laminating, and combinations thereof.

3. The method of claim 1, wherein the photochemically crosslinkable polymer composition comprises a castable glassy thermoset.

4. The method of claim 1, wherein the photochemically crosslinkable polymer composition comprises a castable semicrystalline thermoset.

5. The method of claim 1, wherein the photochemically crosslinkable polymer composition comprises a telechelic polymer, a multifunctional crosslinking agent, and a polymerization initiator.

6. The method of claim 5, wherein the telechelic polymer is selected from the group consisting of telechelic polyurethanes, telechelic polyesters, telechelic poly(allcyl (meth)acrylate)s, and mixtures thereof.

7. The method of claim 5, wherein the telechelic polymer is a telechelic poly(alkylene oxide).

8. The method of claim 5, wherein the telechelic polymer is a telechelic biodegradable polymer selected from the group consisting of di(meth)acrylate esters of polycaprolactone diols, di(meth)acrylate esters of polycaprolactone-polylactide random copolymers, di(meth)acrylate esters of polycaprolactone-polyglycolide random copolymers, di(meth)acrylate esters of polycaprolactone-polylactide-polyglycolide random copolymers, di(meth)acrylate esters of polylactide-polyol random copolymers, di(meth)acrylate esters of polycaprolactone-poly(β-hydroxybutyric acid) random copolymers, di(meth)acrylate esters of poly(β-hydroxybutyric acid), and mixtures thereof.

9. The method of claim 5, wherein the telechelic polymer is a di(meth)acrylate ester of a polyhedral oligosilsesquioxane diol-initiated poly(ε-caprolactone).

10. The method of claim 5, wherein the telechelic polymer is a di(meth)acrylate ester of a polyhedral oligosilsesquioxane diol-initiated polylactide-polyglycolide random copolymer.

11. The method of claim 5, wherein the telechelic polymer is a di(meth)acrylate ester of a poly(ethylene oxide).

12. The method of claim 5, wherein the telechelic polymer is a bifunctional telechelic polymer.

13. The method of claim 5, wherein the telechelic polymer is a bifunctional telechelic polymer wherein each of the two functional groups comprises an aliphatic carbon-carbon double bond.

14. The method of claim 5, wherein the telechelic polymer is a bifunctional telechelic polymer wherein each of the two functional groups is independently selected from the group consisting of vinyl, allyl, (meth)acryl, styryl, benzyl, maleimide, ethynyl, phenyl-ethynyl, and propargyl.

15. The method of claim 5, wherein the telechelic polymer has a glass transition temperature or a melting temperature of about 10 to about 80° C.

16. The method of claim 5, wherein the photochemically crosslinkable polymer composition comprises a polymer comprising internal or pendant aliphatic unsaturation, a multifunctional crosslinking agent, and a polymerization initiator.

17. The method of claim 5, wherein the multifunctional crosslinking agent is a multifunctional thiol.

18. The method of claim 17, wherein the multifunctional thiol is selected from the group consisting of pentaerythritol tetramercaptopropionate, pentaerythritol tetramercaptoacetate, pentaerythritol tetrathioglycolate, trimethylolpropane trimercaptoacetate, trimethylolpropane trimercaptopropionate, 1,2,3-propanetrithiol, 1,2,6-hexanetrithiol, and mixtures thereof.

19. The method of claim 5, wherein the photoinitiator is selected from the group consisting of benzoin ethers, benzil ketals, α-dialkoxyacetophenones, α-hydroxyalkylphenones, α-aminoalkylphenones, acylphosphine oxides, benzophenones, thioxanthones, the combination of camphorquinone and ethyl-4-(dimethylamino)benzoate, and mixtures thereof.

20. The method of claim 1, wherein said illuminating a first region of the article and said illuminating a second region of the article each independently comprises illuminating with light having a wavelength of about 200 to about 700 nanometers.

21. The method of claim 1, wherein said illuminating a first region of the article and said illuminating a second region of the article each independently comprises irradiating with an electron beam.

22. The method of claim 1, wherein the photochemically crosslinkable polymer composition comprises a filler.

23. The method of claim 22, wherein the filler is selected from the group consisting of glass fibers, boron nitride, graphite, carbon fibers, carbon nanotubes, montmorillonite clay, polyhedral oligosilsesquioxane, and mixtures thereof.

24. The method of claim 22, wherein the filler is boron nitride.

25. The method of claim 1, wherein the first shape memory critical temperature and the second shape memory critical temperature are each independently about 10 to about 80° C.

26. The method of claim 1, wherein the first shape memory critical temperature and the second shape memory critical temperature differ by about 1 to about 20° C.

27. A method of forming a photo-tailored shape memory article, comprising:
forming an article comprising a photochemically crosslinkable polymer composition; wherein the photochemically crosslinkable polymer composition comprises
a bifunctional telechelic polymer wherein each of the two functional groups comprises a carbon-carbon double bond,
a multifunctional thiol, and
a substituted or unsubstituted benzophenone;
illuminating a first region of the article with a first light exposure to photochemically crosslink the photochemically crosslinkable polymer composition, thereby creating a first crosslinked polymer having a first shape memory critical temperature; and
illuminating a second region of the article with a second light exposure different from the first light exposure to photochemically crosslink the photochemically crosslinkable polymer composition, thereby creating a second crosslinked polymer having a second shape memory critical temperature.

28. A method of forming a photo-tailored shape memory article, comprising:
forming an article comprising a photochemically crosslinkable polymer composition; wherein the photochemically crosslinkable polymer composition comprises an allyl diterminated polyurethane, pentaerythritol tetra(3-mercaptopropionate), and benzophenone;
illuminating a first region of the article with a first ultraviolet light exposure to photochemically crosslink the photochemically crosslinkable polymer composition, thereby creating a first crosslinked polymer having a first shape memory critical temperature; and
illuminating a second region of the article with a second ultraviolet light exposure different from the first ultraviolet light exposure to photochemically crosslink the photochemically crosslinkable polymer composition, thereby creating a second crosslinked polymer having a second shape memory critical temperature.

29. A method of forming a photo-tailored shape memory article, comprising:
forming an article comprising a photochemically crosslinkable polymer composition; wherein the photochemically crosslinkable polymer composition comprises a polycaprolactone di(meth)acrylate, pentaerythritol tetra(3-mercaptopropionate), and benzophenone;
illuminating a first region of the article with a first ultraviolet light exposure to photochemically crosslink the photochemically crosslinkable polymer composition, thereby creating a first crosslinked polymer having a first shape memory critical temperature; and illuminating a second region of the article with a second ultraviolet light exposure different from the first ultraviolet light exposure to photochemically crosslink the photochemically crosslinkable polymer composition, thereby creating a second crosslinked polymer having a second shape memory critical temperature.

30. A method of programming a photo-tailored shape memory article, comprising:
heating an article comprising
a first photochemically crosslinked polymer composition having a first shape memory critical temperature, and
a second photochemically crosslinked polymer composition spatially separated from the first photochemically crosslinked polymer composition and having a second shape memory critical temperature
to a temperature greater than the first shape memory critical temperature and the second shape memory critical temperature; wherein the first shape memory critical temperature and the second shape memory critical temperature are different;
deforming the first photochemically crosslinked polymer to impress a first desired temporary shape, and deforming the second photochemically crosslinked polymer to impress a second desired temporary shape; and
cooling the article to a temperature below the first shape memory critical temperature and the second shape memory critical temperature.

31. The method of claim 30, wherein the first shape memory critical temperature and the second shape memory critical temperature differ by about 1 to about 20° C.

32. The method of claim 30, wherein said deforming the first photochemically crosslinked polymer and said deforming the second photochemically crosslinked polymer comprise embossing the article.

33. The method of claim 32, wherein said embossing the article comprises embossing a pattern having wavelength in at least one dimension of about 350 to about 750 nanometers.

34. The method of claim 30,
wherein the article has a permanent shape comprising an embossed region having embossed features; and
wherein said deforming the first photochemically crosslinked polymer and said deforming the second photochemically crosslinked polymer comprises compressing the embossed region of the article to form a temporary shape lacking the embossed features.

35. A photo-tailored shape memory article prepared by the method of claim 1.

36. A photo-tailored shape memory article prepared by the method of claim 27.

37. A photo-tailored shape memory article prepared by the method of claim 28.

38. A photo-tailored shape memory article prepared by the method of claim 29.

39. A programmed, photo-tailored shape memory article prepared by the method of claim 30.

40. A sensor for determining whether any of a plurality of predetermined temperatures have been exceeded, comprising:
a photo-tailored shape memory sensor comprising a plurality of photochemically crosslinked polymer compositions;
wherein each photochemically crosslinked polymer composition is the product of photochemically crosslinking the same photochemically crosslinkable composition, and each photochemically crosslinked polymer composition varies from at least one other in the extent of crosslinking;
wherein each photochemically crosslinked polymer composition has a known shape memory critical temperature; and
wherein each photochemically crosslinked composition is embossed with a temporary shape indicative of its known shape memory critical temperature.

41. A sensor for determining whether any of a plurality of predetermined temperatures have been exceeded, comprising:
a photo-tailored shape memory sensor comprising a plurality of photochemically crosslinked polymer compositions;
wherein each photochemically crosslinked polymer composition is the product of photochemically crosslinking the same photochemically crosslinkable composition, and each photochemically crosslinked polymer composition varies from all of the others in the extent of crosslinking;
wherein each photochemically crosslinked polymer composition has a known shape memory critical temperature;
wherein each photochemically crosslinked composition is embossed with a permanent shape indicative of its known shape memory critical temperature; and
wherein each photochemically crosslinked composition has a temporary shape different from the embossed permanent shape.

42. A crosslinked polymer network, comprising the product of photochemically crosslinking a composition comprising:
a polycaprolactone di(meth)acrylate macromer,
a multifunctional thiol, and
a photoinitiator.

43. The crosslinked polymer network of claim 42, wherein the polycaprolactone di(meth)acrylate macromer has the structure 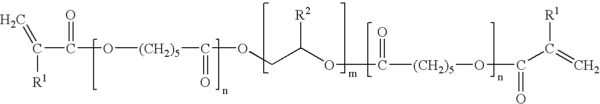
wherein each occurrence of R¹ and R² is independently hydrogen or methyl, m is 1 to about 10, and each occurrence of n is 1 to about 20 provided that the sum of both occurrences of n is at least 4.

44. The crosslinked polymer network of claim 43, wherein each occurrence of R¹ and of R² is hydrogen, and m is 2.

45. The crosslinked polymer network of claim 42, wherein the multifunctional thiol is selected from the group consisting of pentaerythritol tetramercaptopropionate, pentaerythritol tetramercaptoacetate, pentaerythritol tetrathioglycolate, trimethylolpropane trimercaptoacetate, trimethylolpropane trimercaptopropionate, 1,2,3-propanetrithiol, 1,2,6-hexanetrithiol, and mixtures thereof.

46. The crosslinked polymer network of claim 42, wherein the multifunctional thiol is pentaerythritol tetramercaptopropionate.

47. A crosslinked polymer network, comprising repeating units having structure 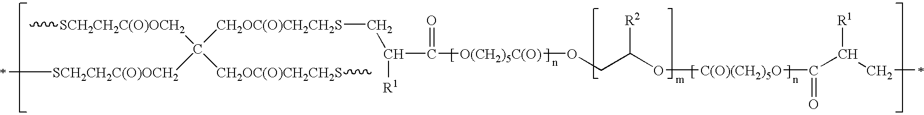
wherein each occurrence of R¹ and R² is independently hydrogen or methyl; each occurrence of m is independently 1 to about 10; each occurrence of n is independently 1 to about 20; and each wavy bond is a bond either to a hydrogen atom or another polycaprolactone diol unit.

48. The crosslinked polymer network of claim 47, wherein m is 2, and each occurrence of R¹ and R² is hydrogen.

49. A crosslinked polymer network, comprising the product of photochemically crosslinking a composition comprising:
a telechelic polymer selected from the group consisting of di(meth)acrylate esters of polyhedral oligosilsesquioxane diol-initiated poly(ε-caprolactone)s, di(meth)acrylate esters of polyhedral oligosilsesquioxane diol-initiated polylactide-polyglycolide random copolymers, and di(meth)acrylate esters of poly(ethylene oxide)s;
a multifunctional thiol, and
a photoinitiator.

50. The crosslinked polymer network of claim 49, wherein the telechelic polymer is a di(meth)acrylate ester of a polyhedral oligosilsesquioxane diol-initiated polylactide-polyglycolide random copolymer; wherein the crosslinked polymer network exhibits two thermally-induced shape memory transitions, each in the temperature range of about 25° C. to about 120° C.; and wherein the two thermally-induced shape memory transitions are separated by at least 10° C.

51. The crosslinked polymer network of claim 49, wherein the multifunctional thiol is selected from the group consisting of pentaerythritol tetramercaptopropionate, pentaerythritol tetramercaptoacetate, pentaerythritol tetrathioglycolate, trimethylolpropane trimercaptoacetate, trimethylolpropane trimercaptopropionate, 1,2,3-propanetrithiol, 1,2,6-hexanetrithiol, and mixtures thereof.

52. The crosslinked polymer network of claim 49, wherein the multifunctional thiol is pentaerythritol tetramercaptopropionate.

53. A polyhedral oligosilsesquioxane diol-initiated poly(ε-caprolactone) having the structure 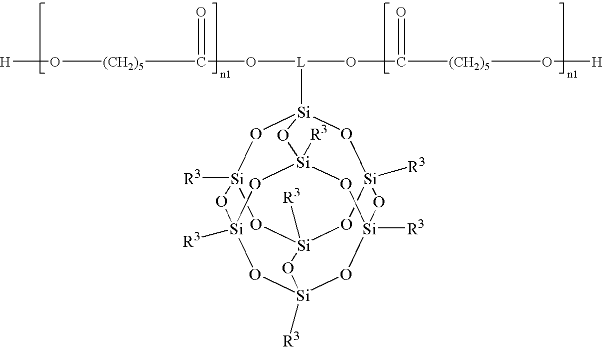
wherein each occurrence of R³ is independently optionally substituted C₁-C₁₂ hydrocarbyl, L is an optionally substituted C₂-C₂₄ trivalent hydrocarbyl linking group, and each occurrence of n1 is independently 1 to 30, provided that the sum of both occurrences of n1 is at least 4.

54. A polyhedral oligosilsesquioxane diol-initiated poly(ε-caprolactone) di(meth)acrylate having the structure 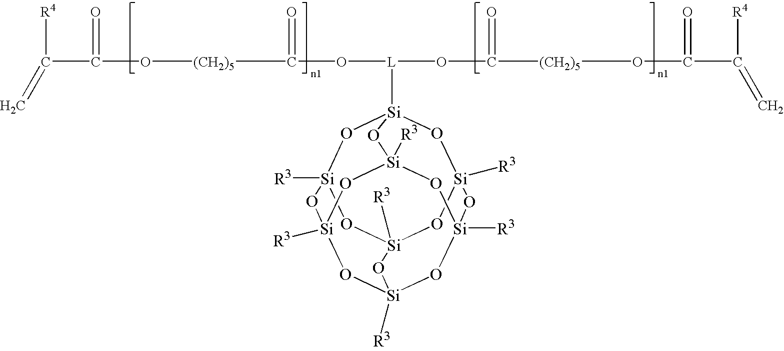
wherein each occurrence of R³ is independently optionally substituted C₁-C₁₂ hydrocarbyl, each occurrence of R⁴ is independently hydrogen or methyl, L is an optionally substituted C₂-C₂₄ trivalent hydrocarbyl linking group, and each occurrence of n1 is independently 1 to 30, provided that the sum of both occurrences of n1 is at least 4.

55. A polyhedral oligosilsesquioxane diol-initiated poly(d,1-lactide-co-glycolide) diol having the structure 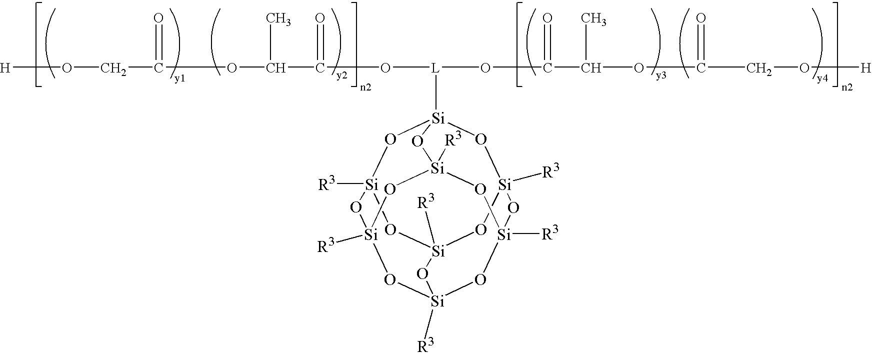
wherein each occurrence of R³ is independently optionally substituted C₁-C₁₂ hydrocarbyl, L is an optionally substituted C₂-C₂₄ trivalent hydrocarbyl linking group, each occurrence of y1, y2, y3, and y4 is independently 0.1 to 0.9 provided that the sum of y1 and y2 is 1 and the sum of y3 and y4is 1, and each occurrence of n2 is independently 1 to 30 provided that the sum of both occurrences of n2 is at least 4.

56. A polyhedral oligosilsesquioxane diol-initiated poly(d,1-lactide-co-glycolide) di(meth)acrylate having the structure 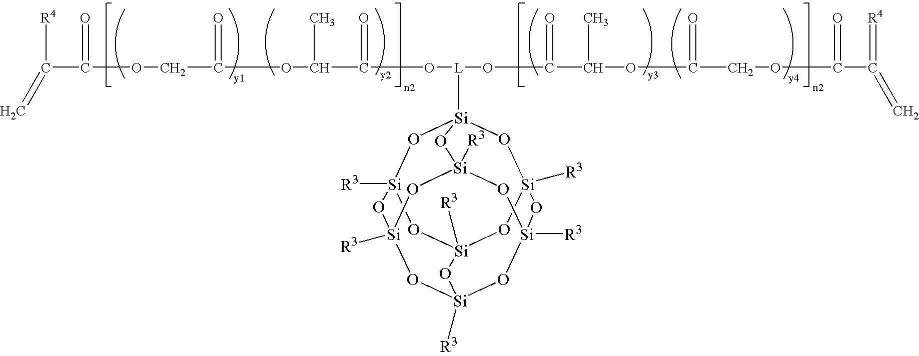
wherein each occurrence of R³ is independently optionally substituted C₁-C₁₂ hydrocarbyl, each occurrence of R⁴ is independently hydrogen or methyl, L is an optionally substituted C₂-C₂₄ trivalent hydrocarbyl linking group, each occurrence of y1, y2, y3, and y4 is independently 0.1 to 0.9 provided that the sum of y1 and y2 is 1 and the sum of y3 and y4is 1, and each occurrence of n2 is independently 1 to 30 provided that the sum of both occurrences of n2 is at least 4.
